(19) United States
(12) Patent Application Publication
(10) Pub. No.: US 2018/0075652 A1
(43) Pub. Date: Mar. 15, 2018

(54) SERVER AND METHOD FOR PRODUCING VIRTUAL REALITY IMAGE ABOUT OBJECT

(71) Applicant: NEXT AEON INC., Seoul (KR)

(72) Inventor: Gyu Hyon KIM, Seoul (KR)

(21) Appl. No.: 15/350,478

(22) Filed: Nov. 14, 2016

(30) Foreign Application Priority Data
Sep. 13, 2016 (KR) 10-2016-0118089
Sep. 30, 2016 (KR) 10-2016-0126242

(51) Int. Cl. G06T 19/00; G06T 17/10; G06T 3/00; G06T 19/20

(52) U.S. Cl. CPC G06T 19/003; G06T 17/10; G06T 3/0062; G06T 2210/04; G06T 2219/2004; G06T 2219/2021; G06T 19/20

(57) ABSTRACT

There is provided a method for producing a virtual reality image about the inside of an offering performed by a server. The method included (a) receiving, from a supplier device, a panoramic image obtained by synthesizing images taken with a camera in multiple directions from a specific reference point in a space of the offering; (b) recognizing a feature, with which a height from a floor to a ceiling and a wall surface structure within the space of the offering are obtained, from the panoramic image; (c) creating a 3D model about the offering on the basis of the feature and the panoramic image in response to an input by the supplier device; and (d) providing a virtual reality image to a consumer device on the basis of the 3D model in response to an input to look up the offering by the consumer device.

### CROSS-REFERENCE TO RELATED APPLICATION

This application claims the benefit under 35 USC 119(a) of Korean Patent Application No. 10-2016-0118089 filed on Sep. 13, 2016 and Korean Patent Application No. 10-2016-0126242 filed on Sep. 30, 2016 in the Korean Intellectual Property Office, the entire disclosures of which are incorporated herein by reference for all purposes.

### TECHNICAL FIELD

The present disclosure relates to a server and a method for producing a virtual reality image about the object.

### BACKGROUND

Due to the advancement of information and communication technology together with the widespread use of smart phones and a resultant increase in use of applications, conventional real estate transaction markets have expanded from offline to online.

Conventional real estate transaction applications provide a consumer with information about a real estate offering previously provided by a supplier, so that the consumer can check the information online. Further, the conventional real estate transaction applications enable the consumer to check a list of offerings uploaded by suppliers and contact a supplier who has an offering the consumer wants, so that a transaction can be made. Such online-based real estate transaction applications have an advantage of reducing time required for the consumer to search offerings.

Herein, the supplier may be a user who wants to sell or rent a real estate offering or a real estate agent who acts for the user. Further, the consumer may be a user who wants to buy or rent a real estate offering.

Furthermore, the information about a real estate offering may include a location, a price, and a floor plan of the real estate offering. The information about a real estate offering may include multimedia information personally taken by the supplier.

Recently, brokerage applications about accommodation- or travel-related offerings have been developed. Such brokerage applications enable consumers to previously see images of the inside of accommodation, so that transactions between suppliers and consumers can be briskly carried out.

Due to the introduction of such online-based brokerage applications, consumers do not need to visit to see offerings but can easily check images of the inside of distant offerings at home. Thus, the online-based brokerage applications can considerably save the consumers trouble.

However, images of real estate offerings provided by suppliers are taken from their point of view and thus may exclude anything against the suppliers. Further, images of real estate offerings may be taken using a wide-angle lens, so that interior spaciousness may be distorted or anything against the suppliers may be excluded.

### SUMMARY

In view of the foregoing, an exemplary embodiment of the present disclosure provides a 360-degree virtual reality image of a space of an offering and thus provides a consumer with reality and spaciousness as if the consumer existed in a real space of the offering in order to provide accurate information about the image of the offering to the consumer.

Further, an exemplary embodiment of the present disclosure provides a supplier with a tool for producing a virtual reality image to be provided to a consumer in order to enable the supplier to easily and conveniently produce the virtual reality image.

As a technical means for solving the above-described problem, in accordance with a first exemplary embodiment, there is provided a method for producing a virtual reality image about the inside of an offering performed by a server. The method included (a) receiving, from a supplier device, a panoramic image obtained by synthesizing images taken with a camera in multiple directions from a specific reference point in a space of the offering; (b) recognizing a feature, with which a height from a floor to a ceiling and a wall surface structure within the space of the offering are obtained, from the panoramic image; (c) creating a 3D model about the offering on the basis of the feature and the panoramic image in response to an input by the supplier device; and (d) providing a virtual reality image to a consumer device on the basis of the 3D model in response to an input to look up the offering by the consumer device. Wherein the virtual reality image is a 360-degree image of the offering which is provided to the consumer device as being implemented to enable each area of the 3D model to be looked up, the 360-degree image includes image data about views from multiple directions from a location of the camera taking the images, and the consumer device is provided with image data about a view from one direction and also provided with image data about a view from another direction in response to an input by the consumer device, and, thus, an image about the space of the offering is provided to the consumer device.

Further, in accordance with a second exemplary embodiment, there is provided a server for producing a virtual reality image about the inside of an offering. The server include a memory that stores therein a program for performing a method for producing a virtual reality image about the inside of an offering; and a processor for executing the program, wherein upon execution of the program, the processor receives, from a supplier device, a panoramic image obtained by combining images taken with a camera in multiple directions from a specific reference point in a space of the offering, recognizes a feature, with which a height from a floor to a ceiling and a wall surface structure within the space of the offering are obtained, from the panoramic image, creates a 3D model about the offering on the basis of the feature and the panoramic image in response to an input by the supplier device, and provides a virtual reality image to a consumer device on the basis of the 3D model in response to an input to look up the offering by the consumer device, the virtual reality image is a 360-degree image of the offering which is provided to the consumer device as being implemented to enable each area of the 3D model to be looked up, the 360-degree image includes image data about views from multiple directions from a location of the camera taking the images, and the consumer device is provided with image data about a view from one direction and also provided with image data about a view from another direction in response to an input by the consumer device, and, thus, an image about the space of the offering is provided to the consumer device.

In accordance with a third exemplary embodiment, there is provided a server for producing a virtual reality image about the inside of an offering. The server includes a communication module that performs data communication with a supplier device; a memory that stores therein a program for performing a method for producing a virtual reality image about the inside of an offering; and a processor for executing the program, wherein upon execution of the program, the processor receives, from the supplier device, an offering image which is a panoramic image obtained by synthesizing images taken with a camera in multiple directions from a specific reference point in a space of the offering, extracts floor surface information and wall surface information corresponding to the panoramic image on the basis of camera information of the panoramic image and information about at least one edge, creates a 3D model of the offering from the panoramic image on the basis of the floor surface information and the wall surface information, provides the 3D model to the supplier model, and provides a virtual reality image to a consumer device on the basis of the 3D model in response to an input to look up the offering by the consumer device, the edge is defined between a wall surface and a wall surface included in the panoramic image, and the 3D model is a 3D image generated by mapping images corresponding to surfaces in the panoramic image into a stereoscopic structure about the offering.

The present disclosure provides a 360-degree virtual reality image of the inside of an offering. Herein, the virtual reality image is a 360-degree image which can be checked from any top/bottom/left/right direction and thus provides a consumer of, e.g., real estate with reality as if the consumer were on the spot checking the inside of the real estate. Further, the 360-degree virtual reality image enables the consumer to take a close look at everywhere the consumer wants to check.

Further, the present disclosure provides a tool that enables a house owner or a real estate agent to easily and conveniently produce such a virtual reality image. Thus, anyone can produce a virtual reality image of his/her own offering and publicize a fact about transaction of his/her offering.

Furthermore, the present disclosure provides a three-dimensional modeling method which can three-dimensionally models a 360-degree panoramic image on the basis of edge information received from a supplier device. Therefore, the present disclosure enables a supplier to easily and simply provide a virtual reality-based three-dimensional image which can provide reality to a user who wants to buy or rent an offering as if the user were on the spot checking the offering.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a configuration view of a system for producing and providing a virtual reality image in accordance with an exemplary embodiment of the present disclosure.

FIG. 2 is a block diagram of a configuration of a server in accordance with an exemplary embodiment of the present disclosure.

FIG. 3A through FIG. 3J illustrate examples of a consumer UI (User Interface) in accordance with an exemplary embodiment of the present disclosure.

FIG. 4A through FIG. 4G illustrate examples of a supplier UI (User Interface) in accordance with an exemplary embodiment of the present disclosure, and specifically, FIG. 4A illustrates a panoramic image taken by a supplier; FIG. 4B illustrates an example in which a feature is displayed; FIG. 4C, FIG. 4E, and FIG. 4G are structural plan views of the inside of real estate; and FIG. 4D and FIG. 4F are examples of a three-dimensional model of the inside of the real estate.

FIG. 5 is a flowchart provided to explain a method for producing a virtual reality image of the inside of an offering in accordance with an exemplary embodiment of the present disclosure.

FIG. 6 is an exemplary diagram showing an offering image in accordance with an exemplary embodiment of the present disclosure.

FIG. 7 is an exemplary view of a 3D model in accordance with an exemplary embodiment of the present disclosure.

FIG. 8 is an exemplary floor plan provided to explain a 3D modeling process in accordance with an exemplary embodiment of the present disclosure.

FIG. 9 is an exemplary view of a horizontal angle and a vertical angle in accordance with an exemplary embodiment of the present disclosure.

FIG. 10 is an exemplary floor plan in accordance with an exemplary embodiment of the present disclosure.

FIG. 11A and FIG. 11B provide exemplary diagrams illustrating a wall in a 3D-modeled image and a wall in a 360-degree panoramic image in accordance with an exemplary embodiment of the present disclosure.

FIG. 12 is an exemplary floor plan provided to explain a 3D modeling process in accordance with an exemplary embodiment of the present disclosure.

FIG. 13A and FIG. 13B provide exemplary diagrams illustrating a 3D model and a 360-degree panoramic image in accordance with an exemplary embodiment of the present disclosure.

FIG. 14A and FIG. 14B provide exemplary diagrams provided to explain a 3D modeling process about an offering image in accordance with an exemplary embodiment of the present disclosure.

FIG. 15 is an exemplary view of a 360-degree panoramic image in which transformed coordinates are mapped in accordance with an exemplary embodiment of the present disclosure.

FIG. 16 is a flowchart a 3D modeling method of a 3D modeling image providing server 200 about an offering image in accordance with an exemplary embodiment of the present disclosure.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “unit” includes a unit implemented by hardware, a unit implemented by software, and a unit implemented by both of them. One unit may be implemented by two or more pieces of hardware, and two or more units may be implemented by one piece of hardware. However, the “unit” is not limited to the software or the hardware, and the “unit” may be stored in an addressable storage medium or may be configured to implement one or more processors. Accordingly, the “unit” may include, for example, software, object-oriented software, classes, tasks, processes, functions, attributes, procedures, sub-routines, segments of program codes, drivers, firmware, micro codes, circuits, data, database, data structures, tables, arrays, variables and the like. The components and functions provided in the “units” can be combined with each other or can be divided up into additional components and “units”. Further, the components and the “units” may be configured to implement one or more CPUs in a device or a secure multimedia card.

A “device” to be described below may be implemented with computers or portable devices which can access a server or another device through a network. Herein, the computers may include, for example, a notebook, a desktop, and a laptop equipped with a WEB browser. For example, the portable devices are wireless communication devices that ensure portability and mobility and may include all kinds of handheld-based wireless communication devices such as IMT (International Mobile Telecommunication)-2000, CDMA (Code Division Multiple Access)-2000, W-CDMA (W-Code Division Multiple Access) and LTE (Long Term Evolution) communication-based devices, a smart phone, a tablet PC, and the like. Further, the “network” may be implemented as wired networks such as a Local Area Network (LAN), a Wide Area Network (WAN) or a Value Added Network (VAN) or all kinds of wireless networks such as a mobile radio communication network or a satellite communication network.

Herein, the supplier may be a user who wants to sell or rent a real estate offering or a real estate agent who acts for the user.

Through the whole document, a “supplier device 300” refers to a device of a supplier who wants to sell or rent an offering such as real estate or a device of a real estate agent who mediates between the supplier or a consumer. Further, the supplier device 300 may be a device of a manager of a 3D modeling image providing server 200 that three-dimensionally models an offering image received from the supplier or the agent. That is, the supplier device 300 refers to a device that three-dimensionally models an offering image and then stores the image in a database or requests transfer of the image to a consumer device 100 of a consumer who wants to buy or rent the real estate.

Through the whole document, a “server 200” may be provided in the form of a service included in an online platform service server that mediates between a supplier or a consumer or an image providing service server. Otherwise, the server 200 may be an offering information providing server that is connected to the online platform service server that mediates between a supplier or a consumer, but is not limited thereto.

Through the whole document, the term “object” may mean “offering”. And the term “offering” is a concept including both of real estate and movable property. For example, the offering and the object may include a building, a house, a boat, a yacht, a car, and the like. Further, the offering may also refer to any object to be taken with a camera. Furthermore, a virtual reality image may be an image of the inside or outside of an offering taken with a camera.

However, in the following, the inside of real estate will be described as a representative example.

Hereinafter, an exemplary embodiment of the present disclosure will be described in detail with reference to the accompanying drawings.

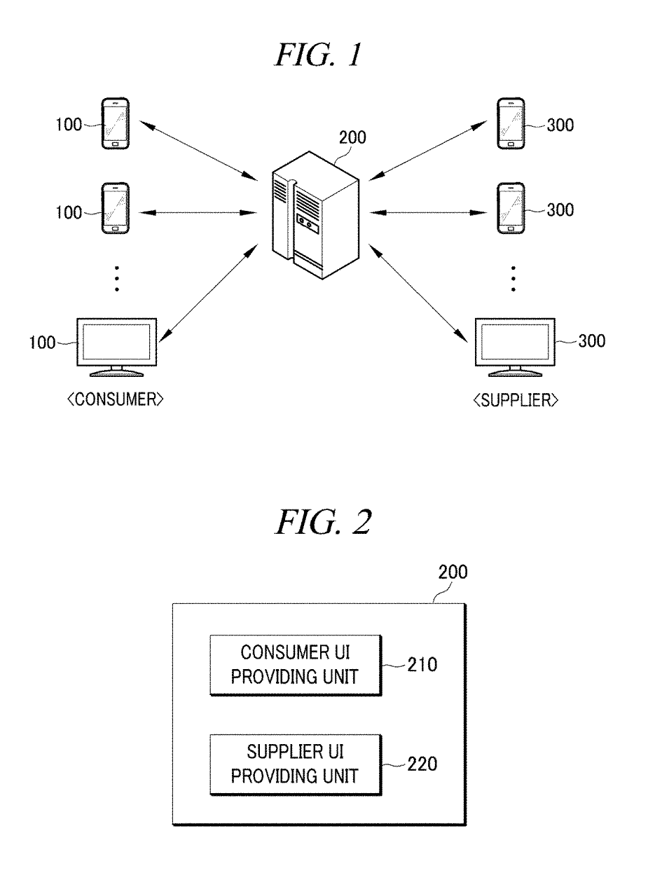

Referring to FIG. 1, a system in accordance with an exemplary embodiment of the present disclosure includes a consumer device 100, a server 200, and a supplier device 300.

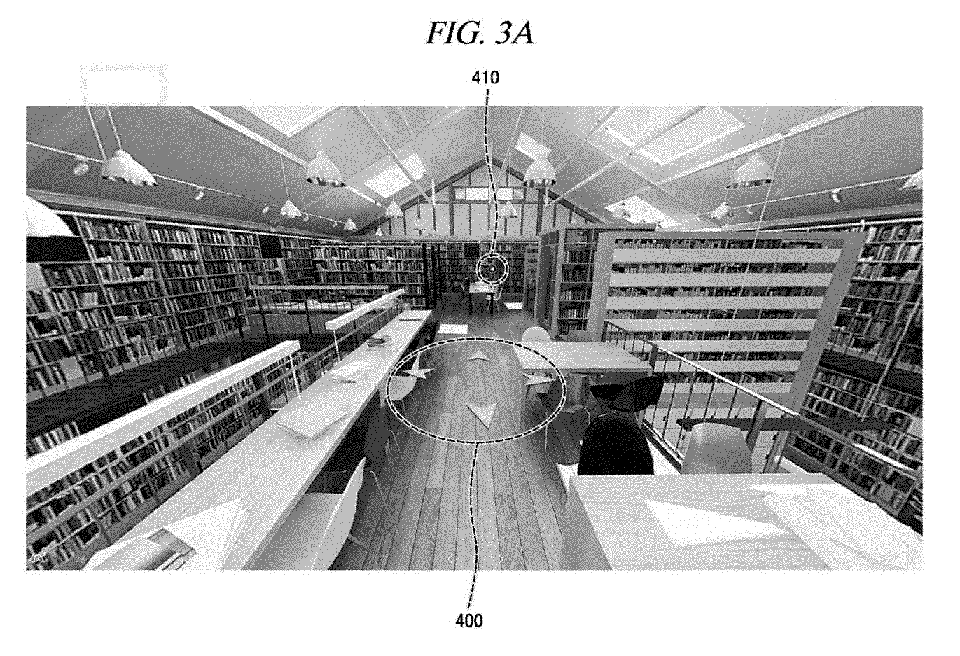

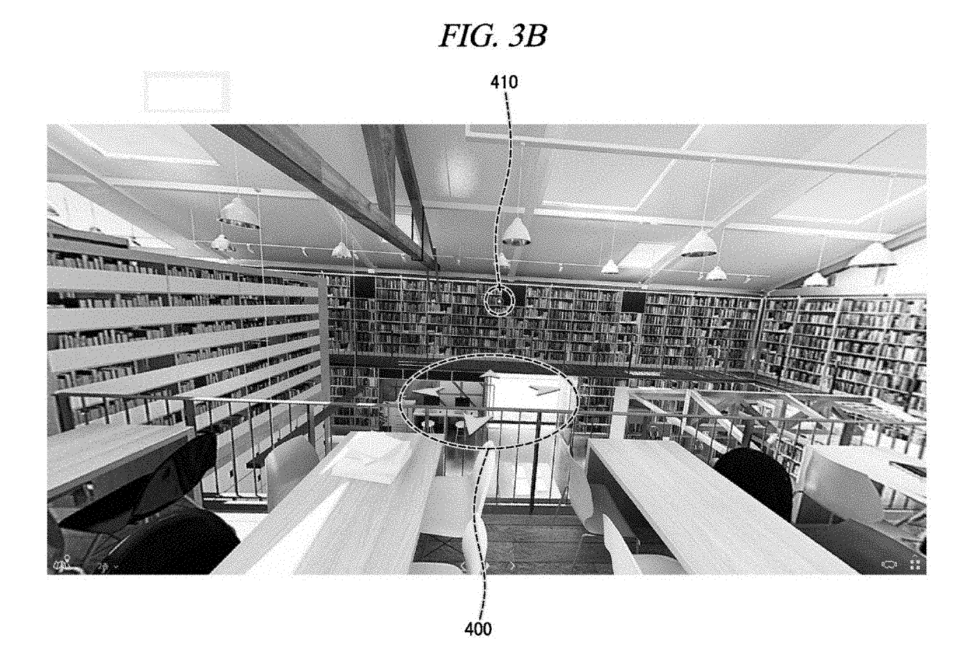

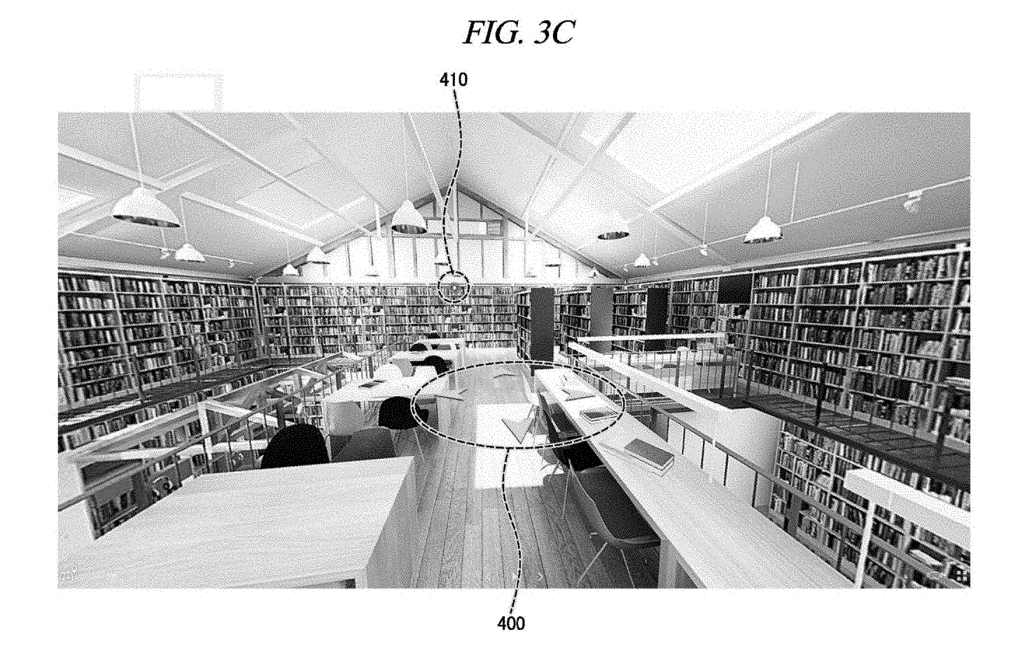

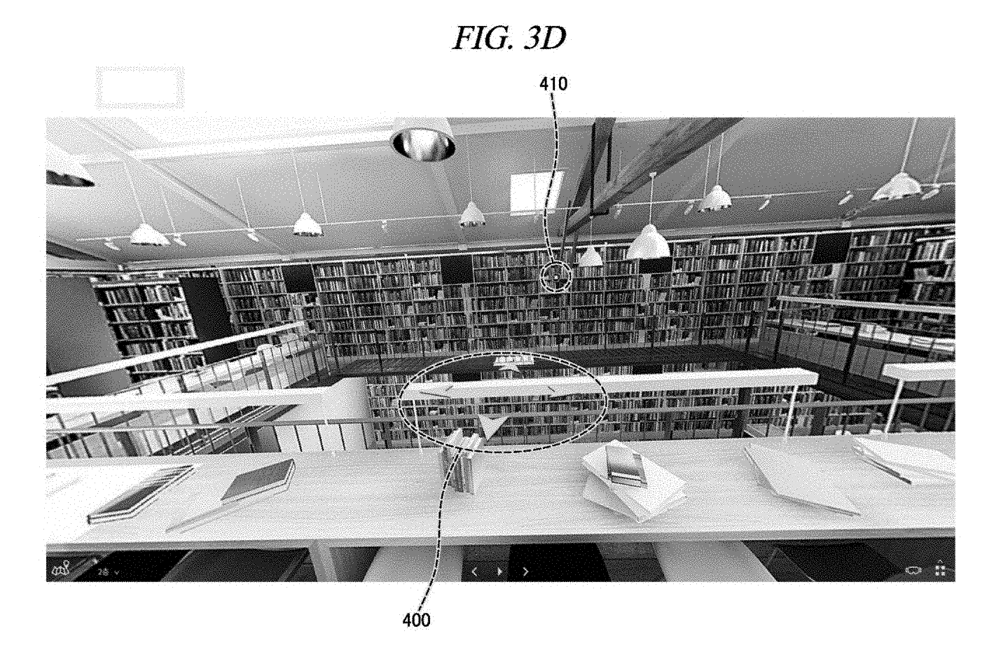

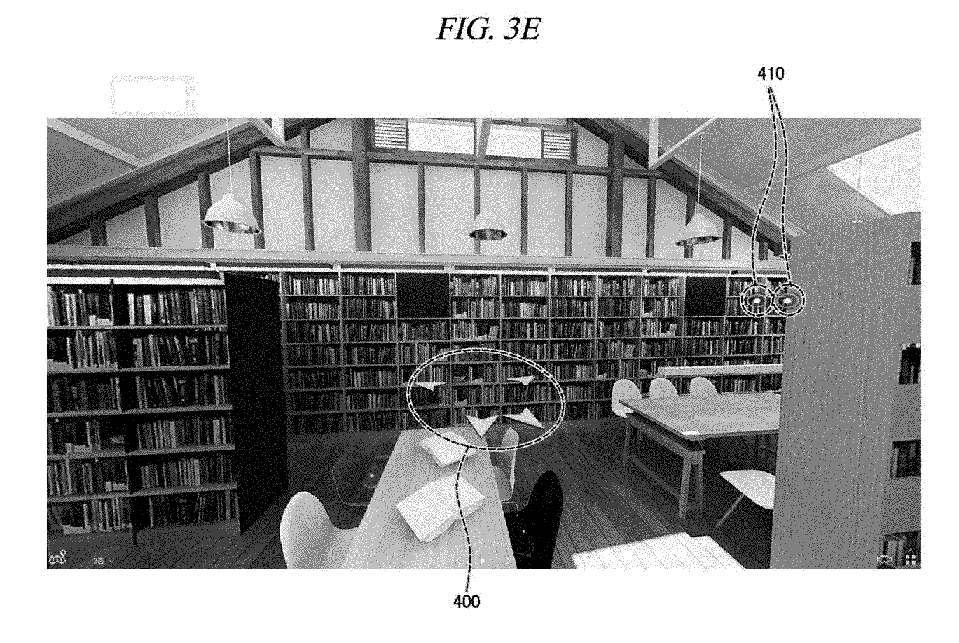

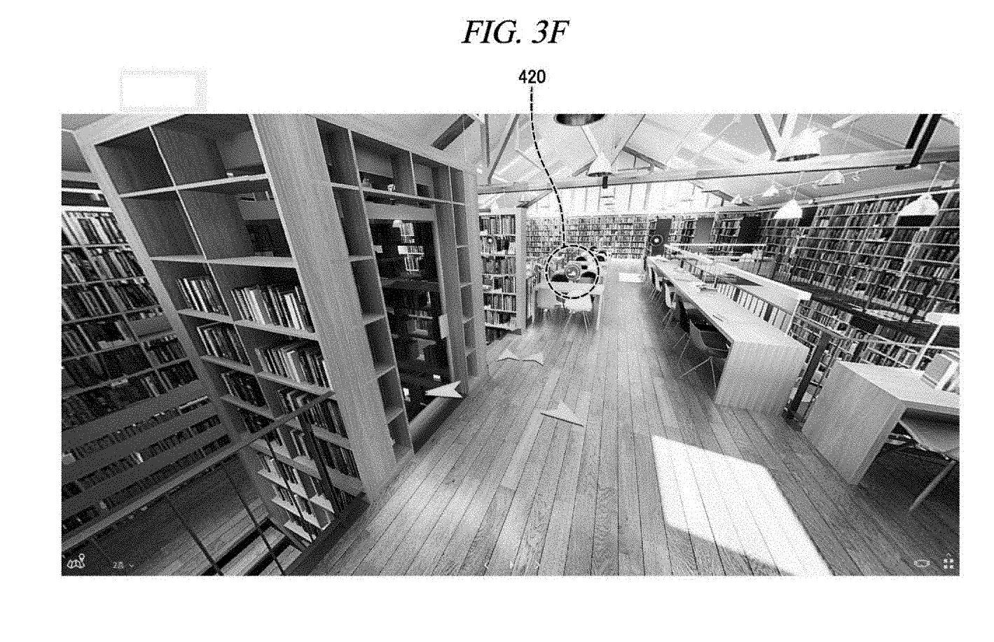

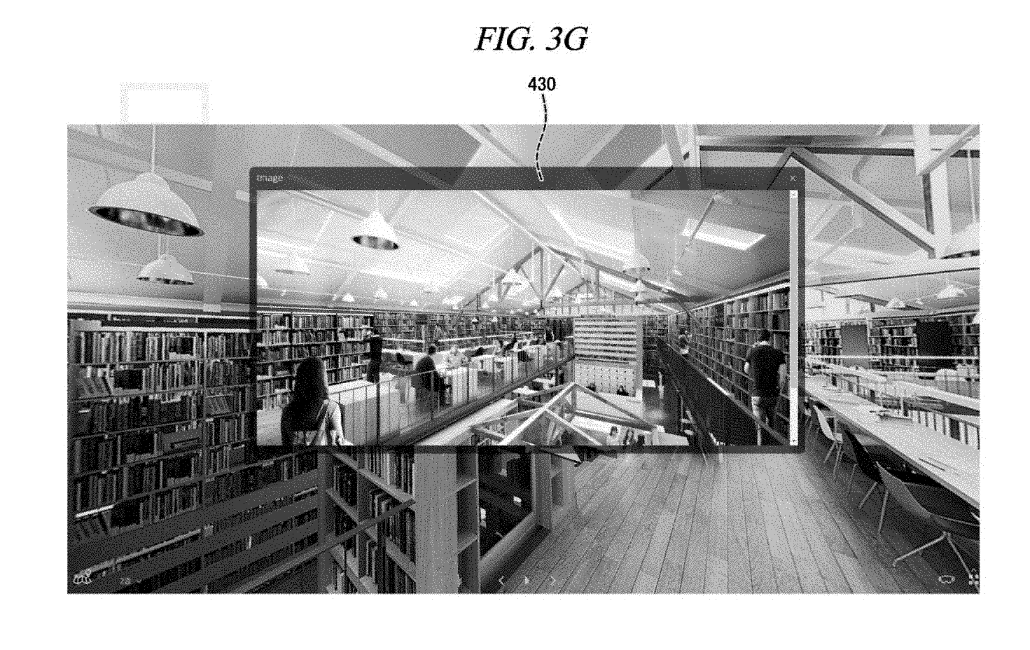

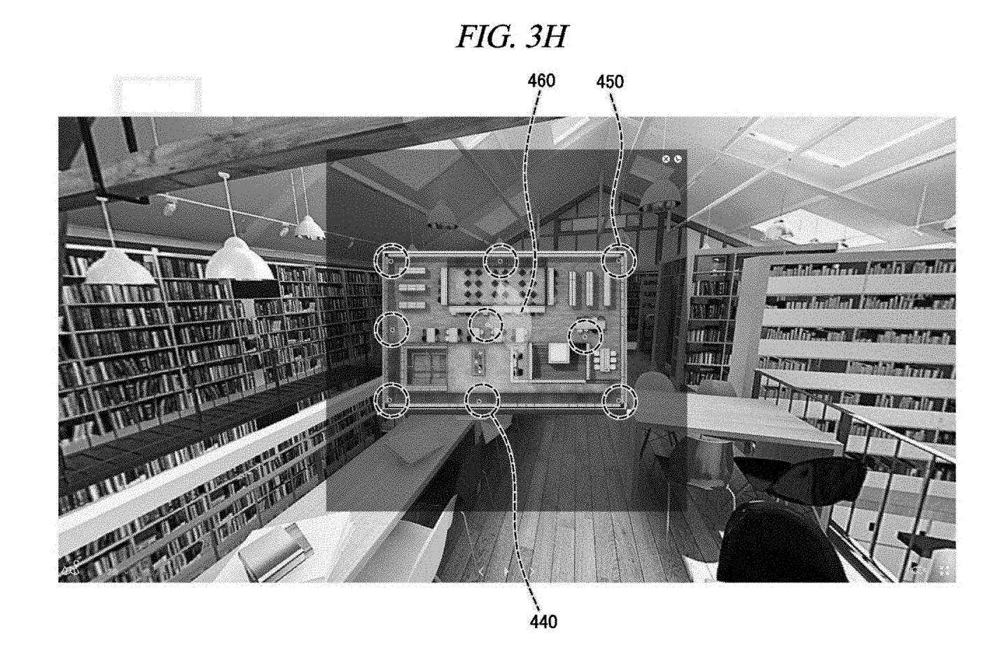

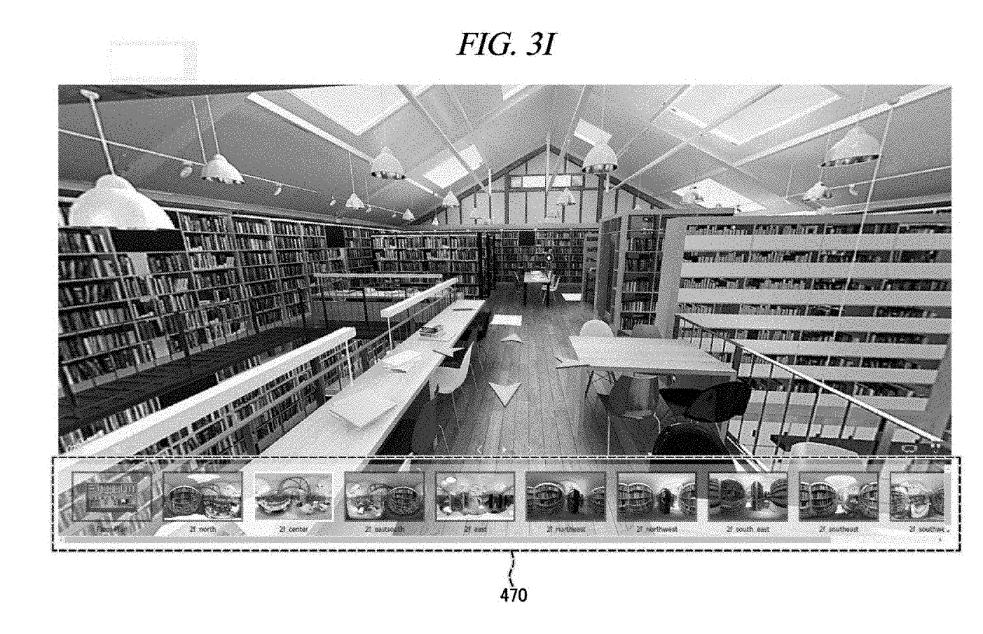

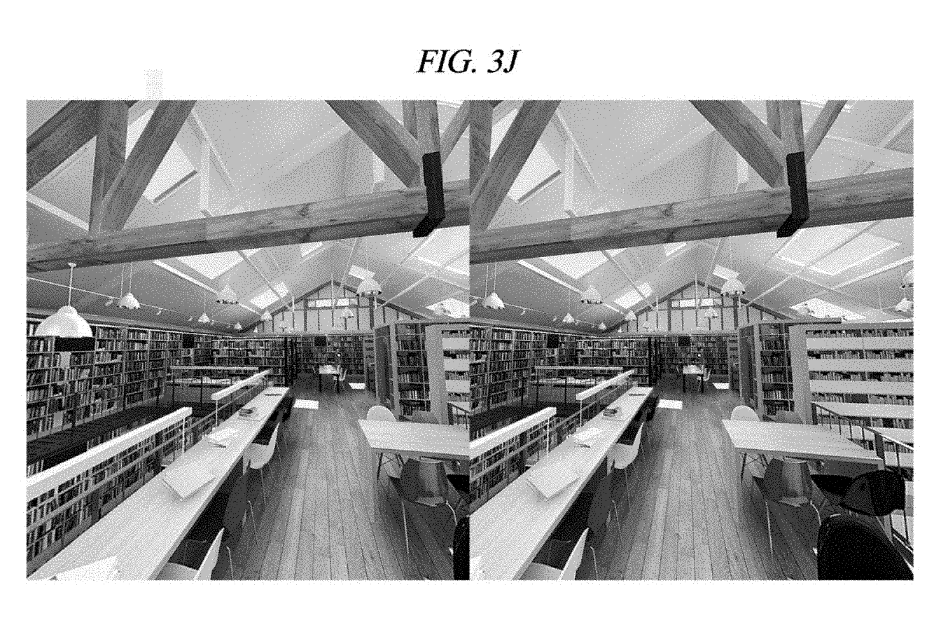

The server 200 provides a virtual reality image of the inside of real estate to consumers. The virtual reality image is an image that provides a consumer with reality as if the consumer were on the spot of the real estate, as illustrated in FIG. 3A through FIG. 3J.

The consumers can acquire more realistic and in-depth information from the virtual reality image than from a typical 2D image and acquire more accurate information about the real estate offering.

Further, the server 200 provides a user interface that enables suppliers to produce a virtual reality image. It is difficult for an ordinary person without skill to produce a virtual reality image. Therefore, the server 200 provides the user interface that enables a user to easily produce a virtual reality image if the user goes through a specific course. Therefore, the suppliers can easily upload virtual reality images of their offerings through the user interface and publicize their offerings.

Referring to FIG. 2, the server 200 may include a memory and a processor. Herein, the memory may store therein a program for providing a virtual reality image of the inside of real estate and a program for producing the virtual reality image. The processor may execute the programs stored in the memory. Further, the processor may perform various functions upon execution of the programs.

The server 200 may include a consumer UI providing unit 210 and a supplier UI providing unit 220 as detail modules depending on a function performed by the processor. Herein, the detail modules may be implemented with software and executed by the processor. Further, the detail modules may functionally represent the processor.

The consumer UI providing unit 210 provides a user interface that enables a consumer to look up a real estate offering.

The consumer may receive a list of real estate offerings through the user interface provided by the consumer UI providing unit 210. Further, the consumer may make a lookup request for an offering selected from the list. In this case, the consumer UI providing unit 210 may receive the lookup request for a virtual reality image selected by the consumer from the consumer device 100. Then, the consumer UI providing unit 210 provides a virtual reality image of the offering corresponding to the request to the consumer device 100.

The virtual reality image includes one or more 360-degree images.

Herein, the 360-degree images are images including still image data or video data about views from all directions from a location of a camera taking a virtual reality image. For example, referring to FIG. 3A through FIG. 3D, one 360-degree image includes images of the front side/right side/back side/left side around a location of a camera. That is, the 360-degree image may include data about all of these front image, right image, back image and left image taken from the location of the camera. Meanwhile, one 360-degree image may include image data of various other sides such as an upper side or a lower side.

Further, the 360-degree image may be a panoramic image in which one or more images are combined. Further, the 360-degree image may be three-dimensionally modeled using the server 200. Herein, a 3D modeling process of a 360-degree image will be described in detail with reference to FIG. 2 through FIG. 14B.

Meanwhile, if the 360-degree image is provided to the consumer device 100, the consumer device 100 is provided with image data about a view from any one of multiple directions included in the 360-degree image. For example, the consumer device 100 may be provided with front image data as shown in FIG. 3A. If the consumer device 100 provides an input to change the direction, the consumer device 100 may be provided with image data corresponding to a view from another direction.

For example, if the consumer device 100 provides an input to change the direction to right from the state displayed on the consumer device 100 in FIG. 3A, image data as shown in FIG. 3B may be displayed on the consumer device 100.

Herein, the input by the consumer device 100 may be a positioning control input which is input through an input module included in the consumer device 100. Herein, the input module may be an input device such as a keyboard, a mouse, a joystick, and a touch pad. Further, the input module may include resistive and capacitive touch screen panels, and may be implemented as being integrated with a display module included in the consumer device 100 or may recognize a user's gesture.

Specifically, if the consumer device 100 is a desktop computer or a notebook computer, the positioning control input may be based on a mouse input or keyboard input to move a cursor in any one direction. Further, if the consumer device 100 is a portable device such as a smart phone or a tablet PC including a touch screen panel, the positioning control input may be an input of flicking or dragging a finger to any one direction.

Further, the 360-degree image may be played through a virtual reality device. Herein, the virtual reality device refers to a device that plays an image covering the whole view of a user. Further, the virtual reality device provides the user with a spatial or temporal experience similar to reality by using the user's motion as a control means.

For example, the virtual reality device may include a head mounted display which directly displays a 360-degree image or displays a 360-degree image through another device. Otherwise, the virtual reality device may be mounted with a device, such as a smart phone, configured to display a 360-degree image and may include two wide-angle lenses installed to be adjacent to the mounted device and the user's eyes.

Thus, in the virtual reality device, image data of a 360-degree image may be changed depending on a change in location of the virtual reality device or a change in location of the smart device when the user sees the 360-degree image. That is, if the user turns his/her head to the right, the virtual reality device may be implemented to look up a right image, and if the user turns his/her head to the left, the virtual reality device may be implemented to look up a left image.

For example, the virtual reality device may be a combination of a card board and a smart device, but is not limited thereto. Herein, the card board is a virtual reality device including a box on which the smart device can be mounted and which can block light, a pair of super wide-angle lenses, a magnet, and an NFC tag. If the smart device is inserted into the card board, the card board is configured to cover the whole view of the user with a 360-degree image played on the smart device through the pair of super wide-angle lenses.

Meanwhile, as for a library as shown in FIG. 3A through FIG. 3J, the whole image of the library cannot be seen just by taking images from one location with a camera. In this case, the virtual reality image is configured to include images taken from multiple locations. That is, the virtual reality image may include two or more 360-degree images taken from different locations as shown in FIG. 3A and FIG. 3E.

If an offering such as a library or a hall has a too wide space to be covered in one 360-degree image, each of 360-degree images included in a virtual reality image may be taken from locations separated from each other. Otherwise, if the offering includes several rooms and each room can be covered in one 360-degree image, 360-degree images may be respectively taken from different rooms.

Each 360-degree image may include information about a location, information about an identifier 410, and a movement identification mark 400.

Each 360-degree image includes location information. Herein, the location information is information about a location where each 360-degree image is taken with a camera. The location information may be absolute information obtained by a GPS or a location sensor, or relative location information to a reference point such as the location of the camera.

Further, the information about the identifier 410 included in each 360-degree image refers to information about the identifier 410 displayed to indicate a location of the present 360-degree image in another 360-degree image.

For example, the identifier 410 may be displayed as a dot as shown in FIG. 3A through FIG. 3E. That is, the identifier 410 may be information provided to show a location of another image relative to the location of the image currently looked up by the consumer. Herein, if the consumer device 100 provides a click input to the identifier 410 in FIG. 3A, the image existing in FIG. 3A is removed and the 360-degree image of FIG. 3E corresponding to the identifier 410 is provided on the consumer device 100. Herein, the identifier 410 is displayed on the basis of location information between a 360-degree image currently provided on the consumer device 100 and another 360-degree image. That is, the location of the identifier 410 displayed in FIG. 3A corresponds to location information of the 360-degree image of FIG. 3E, and, thus, if the location information of the 360-degree image of FIG. 3E is actually on the farther right side, the identifier 410 of FIG. 3A may also be displayed to be on the farther right side.

The movement identification mark 400 may show a movable direction from a location currently looked up by the consumer device 100. The movement identification mark 400 is generated on the basis of location information between a 360-degree image currently provided on the consumer device 100 and another 360-degree image. For example, as for the 360-degree image of FIG. 3A, there are different 360-degree images of the right side, left side, front side, and back side, respectively. Therefore, the movement identification mark 400 may be generated as shown in FIG. 3A. FIG. 3A illustrates the movement identification mark 400 as arrows, but the present disclosure is not limited thereto. For example, the movement identification mark 400 may be implemented in various manners with a shape such as circle, square, triangle, and the like or text indicating a direction.

Meanwhile, referring to FIG. 3F, each 360-degree image may include another mark 420. The mark 420 may include information such as text, image, video, URL, and the like to explain specific information. For example, if the mark 420 in FIG. 3F is clicked on the consumer device 100, a photo 430 may be provided as a separate pop-up window as shown in FIG. 3G. The photo 430 is an image of the library taken from a location of the mark. However, the use of the mark 420 is not limited thereto, but may include information such as text or video to provide various information as described above.

Further, the consumer UI providing unit 210 may further provide a plan map 440 of the inside of an offering in response to an input by the consumer device 100. Referring to FIG. 3H, the plan map 440 of the corresponding floor of the library illustrated in FIG. 3A through FIG. 3F can be seen.

The plan map 440 includes location information 450 of all 360-degree images of the real estate and guide information indicating a direction in which the consumer looks at through the existing 360-degree image. Herein, the guide information 460 may be displayed as a fan shape. A direction of a straight line bisecting the fan shape indicates a direction of the image shown in FIG. 3H. Herein, the center point of the fan shape may be displayed corresponding to a location of the 360-degree image provided on the consumer device 100. Thus, the plan map 440 may also provide the location information 450 of a 360-degree image currently provided on the consumer device 100.

Herein, if another 360-degree image is clicked on the consumer device 100, the 360-degree image may be provided on the consumer device 100.

Further, as shown in FIG. 3I, the processor 230 may display and align a menu 470 including representative images of all 360-degree images included in the virtual reality image to the bottom of the screen. In this case, if the consumer clicks any one representative image on the consumer device 100, the clicked 360-degree image may be displayed on the consumer device 100.

Meanwhile, the consumer UI providing unit 210 may provide a VR button (not illustrated). In this case, if the VR button is clicked on the consumer device 100, a display area of the consumer device 100 is divided into two right and left areas and an image identical to the existing 360-degree image displayed before the input is generated by the consumer device 100 is displayed on the two divided areas as shown in FIG. 3J.

This can be used when the above-described consumer device 100 is connected or can be used for providing a VR image through a head mounted display connected to the consumer device 100. Herein, if an application executed in the consumer device has a function of recognizing the focus of the consumer's eye, when the focus of the consumer's eye turns to an identifier, the screen of the consumer device may be switched to a 360-degree image corresponding to the identifier.

The supplier UI providing unit 220 provides a user interface that enables a supplier to produce a virtual reality image to be provided to the above-described consumer.

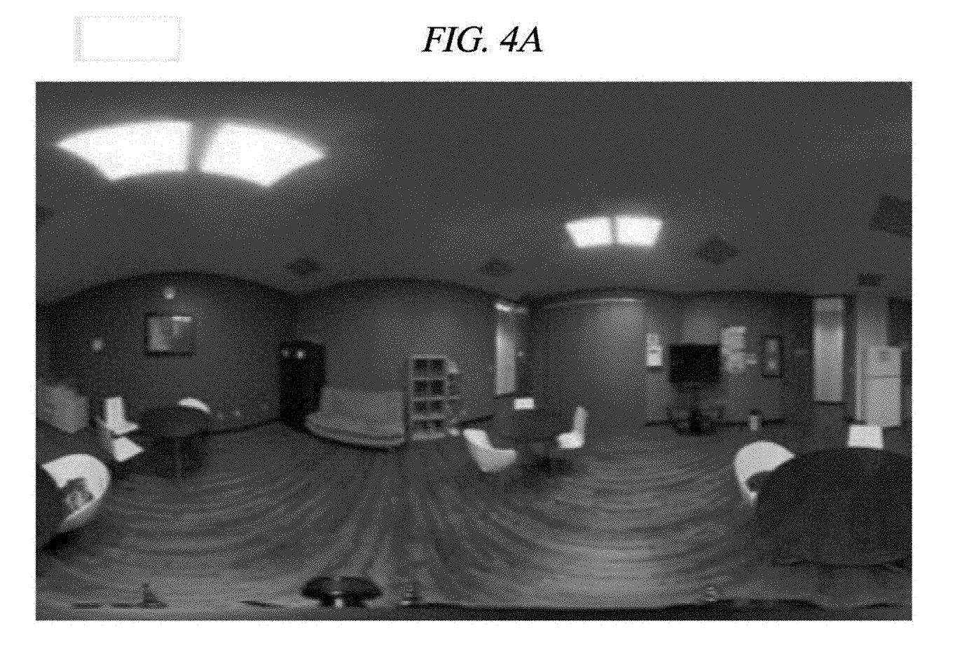

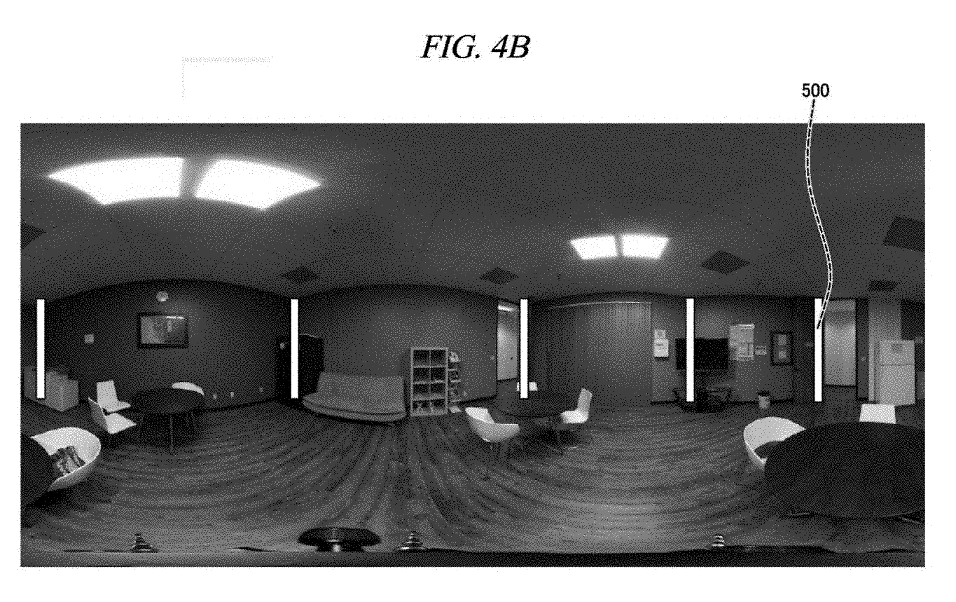

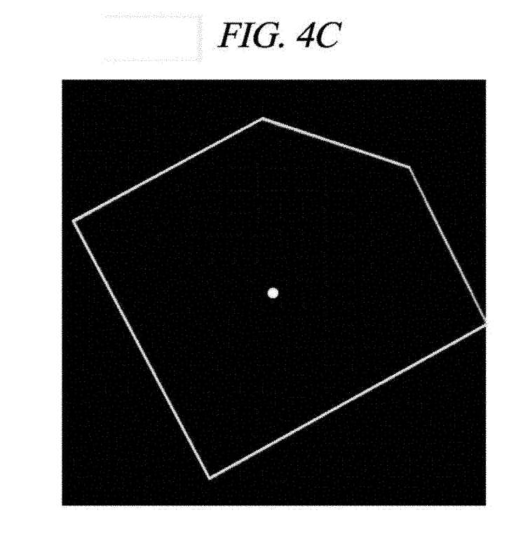

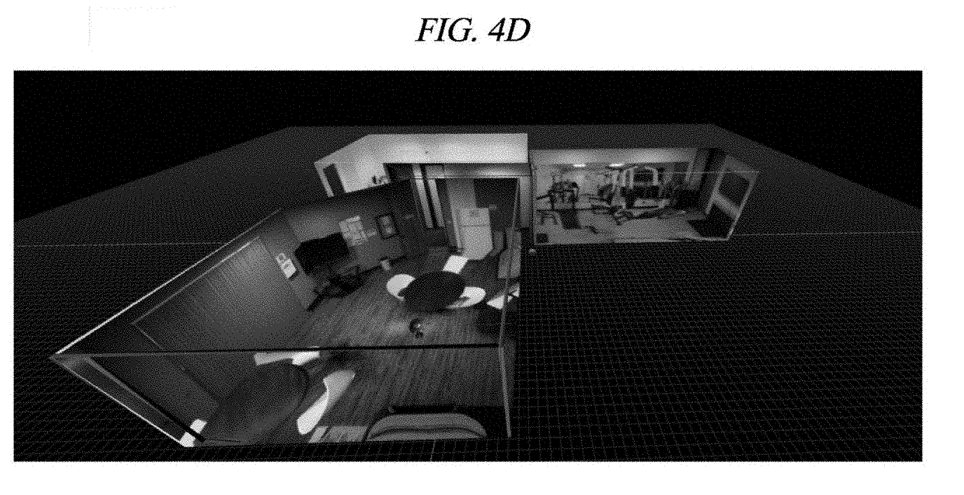

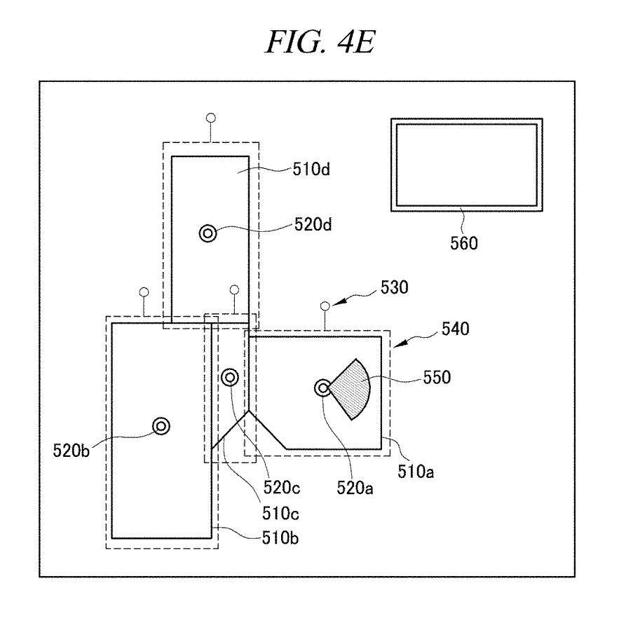

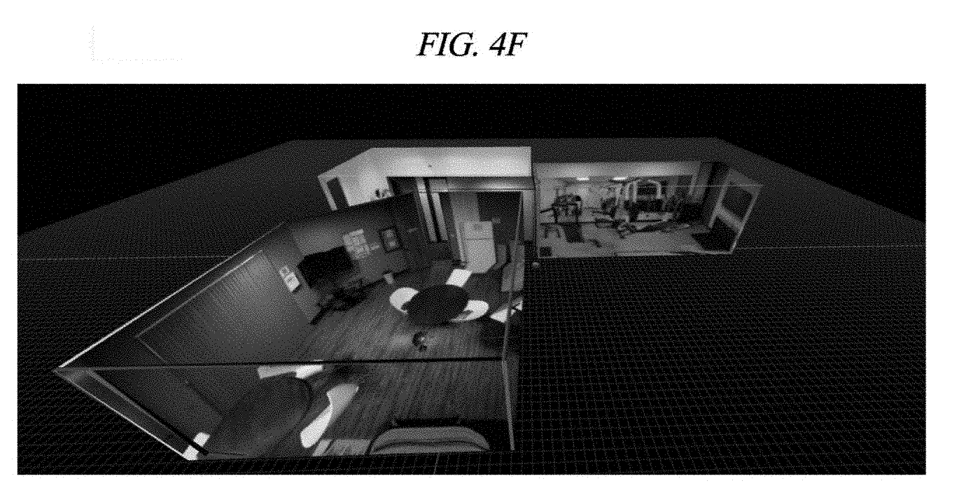

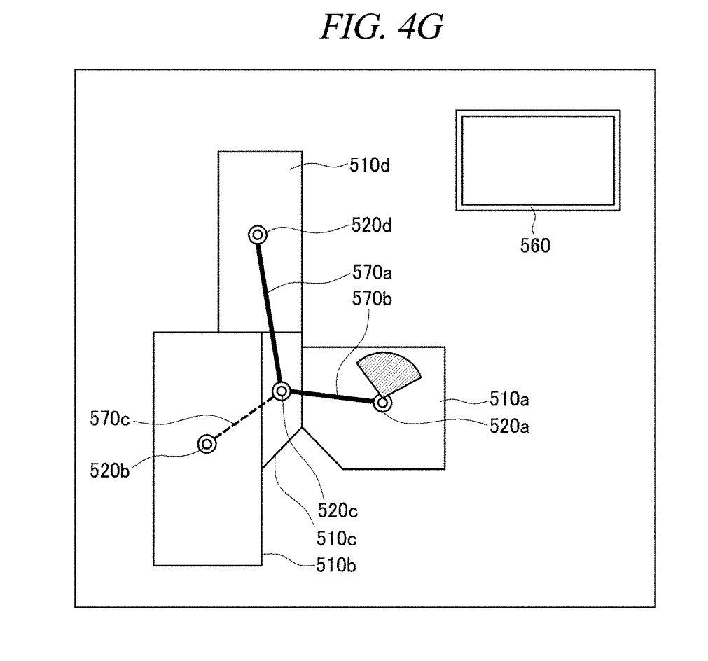

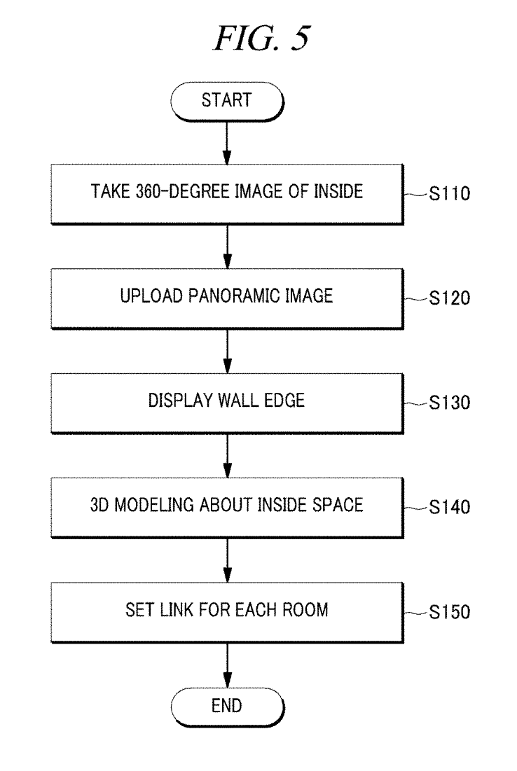

Hereinafter, a method and process for producing a virtual reality image of the inside of real estate using the supplier UI providing unit 220 will be described with reference to FIG. 4A through FIG. 4F and FIG. 5.

Firstly, the supplier takes 360-degree images of the inside (S110). In this case, the supplier may take images using a 360-degree camera or using a combination of a smart device and another device.

For example, in the latter case, 360-degree images of the inside may be taken with a combination of an automatic rotator, a smart device, a wide-angle lens, and a tripod. Herein, the wide-angle lens may be a fisheye lens. For example, the supplier may mount the smart device on the automatic rotator placed on the tripod and install the wide-angle lens on a camera of the smart device. Then, the supplier may set the smart device to take an image at a predetermined interval while the automatic rotator rotates 360 degrees at a constant speed. Through this process, the smart device may acquire images of all directions around a specific reference point such as a location where the smart device is placed in the inside space.

Herein, the images acquired by the smart device may be a panoramic image or multiple images taken from various directions. The panoramic image is an image obtained by connecting different images in parallel to create an effect as if photos which cannot be taken at a time with a single shot of a camera module of the smart device were taken at a time. The panoramic image may be generated from multiple images of various directions taken with the camera module through an image processing module connected to the camera without a separate process by the supplier. Otherwise, the panoramic image may be generated by combining images into one through a separate process by the smart device in response to a request of the supplier.

For example, the supplier may acquire a panoramic image as shown in FIG. 4A through the smart device.

Then, when the supplier uploads the panoramic image to the server 200, the supplier UI providing unit 220 may receive the panoramic image from the supplier device 300 (S120).

Then, the supplier UI providing unit 220 may extract a feature, with which the height from a floor to a ceiling and a wall surface structure within the real estate can be obtained, from the panoramic image. Herein, the feature may be calculated on the basis of information about a wall edge (S130).

Herein, the supplier UI providing unit 220 may automatically recognize the wall edge from the panoramic image, or may recognize the wall edge in response to an input by the supplier device 300.

Specifically, in the latter case, the supplier UI providing unit 220 may guide the supplier device 200 to be able to draw line segments 500 in the panoramic image. Thus, the supplier device 300 may enable the supplier to indicate wall edges as the line segments 500 as shown in FIG. 4B. For example, the line segments 500 may be displayed with a high-chroma color to be distinguished from the other parts.

The supplier UI providing unit 220 can find locations and lengths of the wall edges on the basis of the lengths and the locations of the line segments 500. Further, the supplier UI providing unit 220 may detect a floor shape within the real estate on the basis of the locations of the wall edges. For example, in case of FIG. 4B, the supplier UI providing unit 220 may detect a floor shape as shown in FIG. 4C. Further, the supplier UI providing unit 220 detects a height from a floor to a ceiling within the real estate on the basis of the lengths of the wall edges.

Meanwhile, in an additional exemplary embodiment, the wall edges personally indicated by the supplier may be inaccurate. Therefore, the supplier UI providing unit 220 may previously perform an additional process of correcting all of the wall edges to be identical to each other in length, and a length value may be input by the supplier.

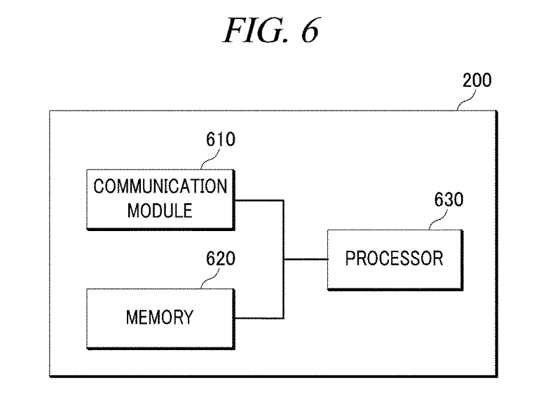

Then, the supplier UI providing unit 220 performs 3D modeling of the inside of the real estate to generate a 3D model of the inside of the real estate on the basis of the feature and the panoramic image in response to an input by the supplier device 300 (S140). The 3D modeling process will be described in detail with reference to FIG. 6 through FIG. 15.

Herein, the 3D model refers to stereoscopic image data about a room taken with the camera in the inside space of the real estate as shown in FIG. 4D.

Referring to FIG. 4D, it can be seen that each area of the 3D model is matched with a corresponding image in the panoramic image divided by the feature. That is, it can be seen that an image corresponding to a wall surface in the panoramic image is displayed as being matched with the corresponding wall surface of the 3D model and the other parts except the wall surface are matched with a floor surface.

Further, FIG. 4D shows a part displayed as a specific shape at the center of the 3D model. Herein, the specific shape at the center refers to a reference point where the panoramic image is taken. For example, the specific shape may be a camera shape.

That is, the reference point is matched with a specific location in the 3D model, and each area of the 3D model can be looked up on the basis of the reference point. Specifically, if the supplier device 300 selects the 3D model in order to take a close look at the 3D model, image data about each area (i.e., wall surface or floor surface) on the basis of the reference point are provided to the supplier device 300. If the supplier device 300 provides an input to change the direction, the supplier UI providing unit 220 provide image data about another area of the 3D model to the supplier device 300. That is, a 360-degree image supplied through the consumer UI can be produced by 3D modeling of forming a 3D model and matching each area of a room with image data corresponding thereto.

Meanwhile, if the real estate includes multiple rooms therein or if the whole inside space of the real estate such as a library cannot be covered in one panoramic image, the supplier UI providing unit 220 may generate multiple 3D models as shown in FIG. 4D by repeatedly performing S110 through S140.

Further, the supplier UI providing unit 220 may perform an additional process of editing a location, a size, a direction, and a shape of the 3D model in response to an input by the supplier device 300. The editing operation may be performed by providing a structural plan view of multiple 3D models to the supplier device 300 and receiving a result of editing from the supplier device 300.

Herein, the structural plan view may be provided as shown in FIG. 4E. Specifically, the structural plan view includes floor shapes 510a to 510d of the 3D models, reference points 520a to 520d of the respective 3D models, orientations 530 at a start time of taking panoramic images with cameras, image ranges 550 on the basis of the reference points in which the 3D models can be provided on a screen of the consumer device 100, and image data 560 corresponding to the present image range.

The floor shapes of the 3D models refer to plan view of the respective rooms when viewed from the top to the bottom. The reference points 520a to 520d refer to locations of cameras where panoramic images are taken.

Meanwhile, the orientations 530 may be used as auxiliary means for connecting the rooms. The 3D models are not aligned as shown in FIG. 4E as soon as they are generated. That is, the 3D models are generated at random locations, and the user may align the 3D models as shown in FIG. 4E by editing to adjust locations and directions of the respective 3D models. Herein, the 3D models may be generated at random locations. In this case, the 3D models may be aligned such that the orientations 530 point in the same direction. Further, the floor shapes of the 3D models are aligned on the basis of the orientations 530. If all the rooms are identical to each other in orientation 530 at the time of taking panoramic images, when the server 200 generates multiple 3D models, all the 3D models are automatically aligned to look in the same direction. In this case, if the 3D models are aligned, the supplier device 300 can easily perform an editing operation.

If there is a difference in orientation 530 at the time of taking panoramic images, the server 200 needs to adjust locations and directions of the 3D models with reference to the image ranges 550 of the 3D models which can be provided on the screen of the consumer device 100 and the image data 560 corresponding thereto. The image ranges 550 may be displayed in the form of a fan-shaped radar beam and rotated 360 degrees around the reference points 520a to 520d. A part of a panoramic image in a direction indicated by the image range 550 may be displayed as the image data 560 in a separate area.

Meanwhile, the contents of the image data 560 corresponding to the image range 550 is not illustrated in the drawing. However, in response to an input of the supplier to adjust a direction of the image range 550, the image data 560 may also be changed and then displayed. That is, the supplier can recognize which way of the 3D model is south by adjusting a direction of the image range 550. Further, if directions of all the 3D models are adjusted to be identical to each other, the supplier can complete a structural plan view of the whole inside of the real estate.

Further, the server 200 may perform an editing operation of generating a window in each 3D model. Specifically, the server 200 may receive an input to specify a certain area of the 3D model as a polygonal shape from the supplier device 300. For example, if image data corresponding to each area of a 3D model includes an area such as a window or a door, the supplier device 300 may input a mark connecting borders of the window and the door. In most cases, a square mark may be input. The supplier UI providing unit 220 deletes image data present within the mark. The deleted area is provided as a null value. If there is another 3D model beside the deleted image data as shown in FIG. 4F, the supplier device 300 may display an image of the 3D model through the deleted area. Referring to an area bordered with a bold color in FIG. 4F, it can be seen that an image of another room is displayed through the door of one room.

Then, the supplier UI providing unit 220 of the server 200 may set links 570a to 570d for the respective rooms (S150).

Specifically, referring to FIG. 4G, when an input to specify between the reference points 520a to 520d of the multiple 3D models is received from the supplier device 300, the supplier UI providing unit 220 may form the links 570a to 570d between the adjacent 3D models. The links 570a to 570d formed by the supplier UI providing unit 220 may be displayed as solid lines connecting between the reference points 520a to 520d of the adjacent 3D models. If the links 570a to 570c are clicked once more on the supplier device 300, the supplier UI providing unit 220 may cancel the link 570c. The canceled link 570c is displayed as a broken line.

By setting the links 570a to 570c as such, the identifier 410 and the movement identification mark 400 can be implemented in the virtual reality image as shown in FIG. 3A through FIG. 3J. That is, a 360-degree image provided to the consumer device 100 displays only the identifiers 410 of other 360-degree images connected thereto via the links 570a to 570c. Further, the 360-degree image generates the movement identification marks 400 on the basis of locations and the number of other 360-degree images connected thereto via the links 570a to 570c. Therefore, a moving line along which the consumer looks up the inside space of the real estate may be determined depending on the links 570a to 570c set by the supplier.

Generally, in case of FIG. 4G, a middle room 510c serves as a path to other rooms 510a, 510b, and 510d, and, thus, the supplier UI providing unit 220 may set the links 570a to 570c connecting the middle room 510c to the other rooms 510a, 510b, and 510d.

Through the above-described process, the supplier UI providing unit 220 may complete 3D modeling about the inside of the real estate. Then, the server 200 provides a virtual reality image to the consumer UI on the basis of the 3D modeling information.

Hereinafter, a 3D modeling process of the 3D modeling image providing server 200 will be described with reference to FIG. 6 through FIG. 15.

FIG. 6 is a block diagram of the 3D modeling image providing server 200 in accordance with an exemplary embodiment of the present disclosure.

Referring to FIG. 6, the 3D modeling image providing server 200 may include a communication module 610, a memory 620, and a processor 630.

Herein, the communication module 610 performs data communication with the supplier device 300.

Further, the memory 620 stores therein a 3D modeling program about an image. Herein, the memory 620 generally refers to a non-volatile storage device that retains information stored therein even if power is not supplied thereto and a volatile storage device that needs power to retain information stored therein.

The processor 630 models an image received from the supplier device 300 or selected by the supplier device 300 from among images stored in the database on a 3D image.

For example, if the supplier is a real estate agent, an image received through the supplier device 300 may be a 360-degree image of real estate, such as a building, a house, an office, and the like, for sale or rent. In this case, the image may include data about one or more 360-degree images of one or more spaces such as rooms in the real estate.

Further, the image may be an area image of one or more areas included in an offering which the supplier wants to rent or sell to the consumer. Herein, the area image may be an image corresponding to each space included in the inside or the outside of the offering. For example, the area image may be an image of a room included in a house. Otherwise, the area image may be obtained by dividing one inside space into multiple virtual spaces separated from each other and then generating an image of a virtual space. For example, the area image may be obtained by dividing one large space, such as a library, into multiple virtual spaces and then generating an image of each virtual space.

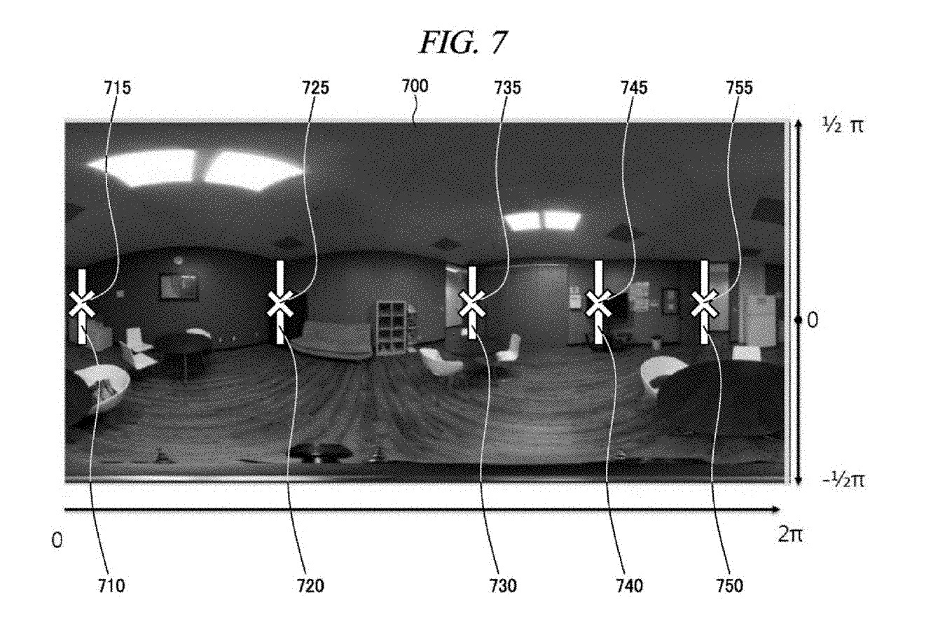

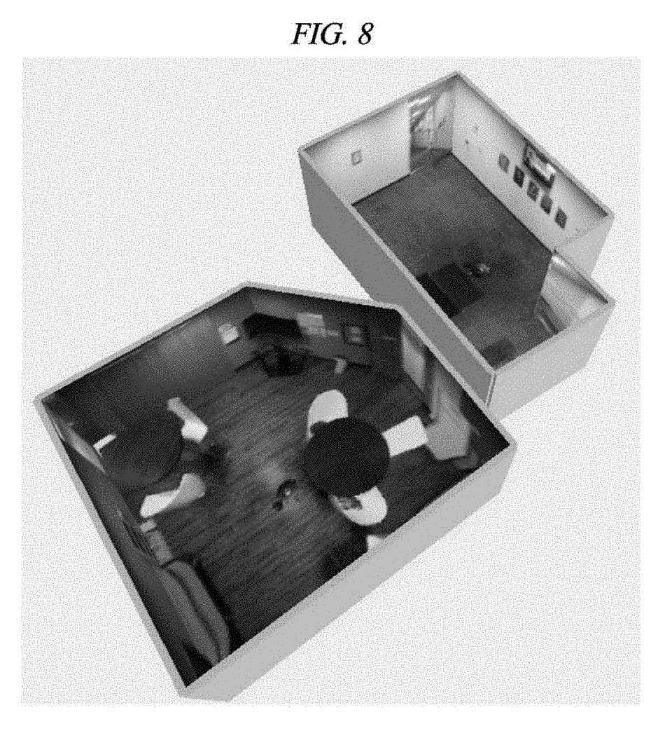

In the following, an offering image may refer to the image or area image described above. That is, the offering image may be the whole image of real estate or an offering or may be an image of one or more areas included in the real estate or the offering, but is not limited thereto. Further, in the following, the offering image refers to a 360-degree panoramic image which can be mapped in a 3D space by performing 3D modeling. Further, a 3D model may be a 3D image mapped in a 3D space by 3D modeling the offering image. The offering image and the 3D model will be described in detail with reference to FIG. 7 and FIG. 8.

FIG. 7 is an exemplary diagram showing an offering image in accordance with an exemplary embodiment of the present disclosure.

Referring to FIG. 7, an offering image 700 may be a 360-degree panoramic image of a specific area within an offering on the basis of a camera.

Herein, the camera may be a 360-degree camera manufactured to produce a 360-degree panoramic image. Otherwise, the camera may be configured as a combination of an automatic rotator and a normal camera including an image sensor or a smart device. For example, the camera may be a configured as a combination of an automatic rotator, a smart device, a lens, and a tripod. Herein, the lens may be a wide-angle lens with a wide view angle capable of magnification-photographing from a ceiling to a floor surface in a space, or particularly a wide-angle fisheye lens with a view angle of 180 degrees or more, but is not limited thereto.

Herein, a coverage of the 360-degree panoramic image may be the entire space of the area taken with the camera. Referring to FIG. 7, the 360-degree panoramic image horizontally covers the entire space, i.e., 360 degrees. Further, the 360-degree panoramic image vertically covers 90 degrees up and down on the basis of the location of the camera.

As described above, in the 360-degree panoramic image, a 3D space is mapped into a 2D image using a wide-angle or fisheye lens. Therefore, referring to FIG. 7, in the 360-degree panoramic image, a part of the space taken with the camera may be distorted.

FIG. 8 is an exemplary view of a 3D model in accordance with an exemplary embodiment of the present disclosure.

Referring to FIG. 8, the processor may generate a 3D model by mapping a 2-dimensional 360-degree panoramic image in a 3D space through a 3D modeling process. The 3D model is obtained by connecting a floor surface and a wall surface of an offering corresponding to an offering image in three dimensions. Further, the 3D model may be obtained by matching areas included in the offering image with corresponding floor surfaces and wall surfaces, respectively.

Meanwhile, the processor 630 may perform a pre-treatment to the offering image in order to perform 3D modeling.

For example, the processor 630 may adjust a width length or a height length such that a ratio of a width length and a height length of the offering image becomes equal to a predetermined length ratio. Herein, the predetermined ratio may be 1:2 as shown in FIG. 7, but is not limited thereto.

Further, the processor 630 may extract edge information from information of the previously stored offering image. Otherwise, the processor 630 may receive edge information of the offering image from the supplier device 300 through the communication module 610.

Herein, an edge may be defined between a wall surface and a wall surface included in the offering image. Further, edge information may be a length or coordinate information of each edge.

For example, the edge information may be coordinates input by the supplier device 300. That is, the supplier device 300 may directly input coordinate information of multiple edges included in an image through the supplier user interface. The processor 630 may recognize the number and locations of edges using the coordinate information input by the supplier device 300.

Further, the edge information may be extracted on the basis of a line segment input into the offering image by the supplier device 300 through the user interface.

For example, the processor 630 may display the offering image through the communication module 610 and transfer the user interface, through which an input signal corresponding to the offering image can be input, to the supplier device 300. The supplier device 300 may input a line segment corresponding to a first edge 710 in the offering image 700 through the user interface. Further, the processor 630 may extract information about the first edge 710 including coordinates of the first edge 710 on the basis of the line segment input through the supplier device 300.

As such, the processor 630 may extract information about a second edge 720, a third edge 730, a fourth edge 740, and a fifth edge 750 on the basis of line segments input through the supplier device 300.

Herein, the line segment received through the supplier device may not be a straight line. Therefore, the processor 630 may perform a pre-treatment to the line segment input through the supplier device 300. For example, the processor 630 may perform a pre-treatment to the line segment input through the supplier device 300 by changing the line segment into a straight line on the basis of coordinates of a start point of the line segment and coordinates of an end point of the line segment. Then, the processor 630 may extract edge information from the line segment to which the pre-treatment has been performed.

Further, the processor 630 may receive camera information corresponding to the offering image from the supplier device 300 through the communication module 610. Herein, the camera information may be coordinates of a location of the camera or a height of the camera at the time of taking the offering image.

Herein, a height or length included in the edge information and camera information may be given in the unit of pixel or may have a length unit such as mm, cm, and inch, but is not limited thereto. Further, coordinates included in the edge information and camera information may be absolute coordinates obtained using a GPS or relative coordinates to a specific point.

Meanwhile, the processor 630 may calculate floor surface information corresponding to an offering image 600 on the basis of information of each edge. Herein, the floor surface information may include a horizontal angle and a vertical angle of each edge. Further, the floor surface information may include plane coordinates of a location of each edge.

For example, the horizontal angle may be a relative horizontal angle of each edge to a reference point which is calculated on the basis of the camera information and coordinates of a location of each edge. Further, the vertical angel may be a relative vertical angle calculated on the basis of the camera information and coordinates of a location of each edge.

Herein, the reference point may be a location of the camera taking the offering image. Otherwise, the reference point may be a predetermined point, but is not limited thereto.

Further, the processor 630 may calculate relative horizontal angle and vertical angle of each edge on the basis of coordinates of a location of each edge and the reference point.

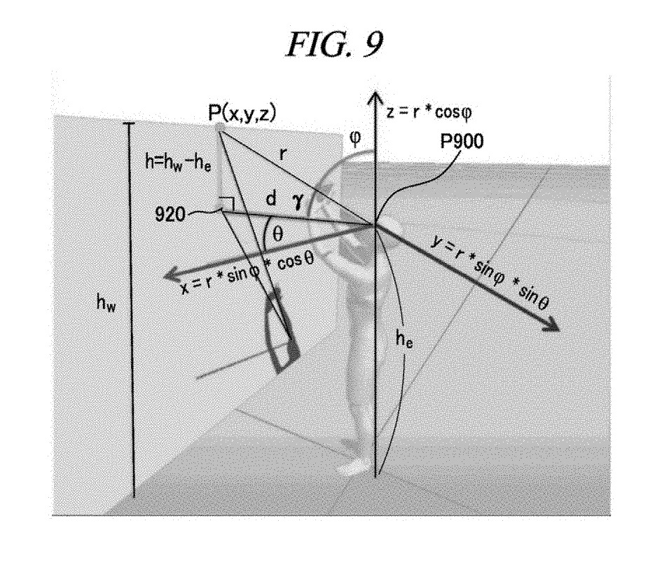

FIG. 9 is an exemplary view of a horizontal angle and a vertical angle in accordance with an exemplary embodiment of the present disclosure.

Referring to FIG. 9, a height of a reference point P900 from a floor surface may be denoted as “he”, and a height of a specific point P from the floor surface may be denoted as “hw”. That is, a difference between the specific point P and the reference point P900 may be represented as “hw-he”.

Further, a distance between the reference point P900 and the specific point P may be denoted as “r”. A horizontal angle may be an angle θ between the specific point P and a certain edge in a direction parallel to the floor surface on the basis of the reference point P900. Further, a vertical angle may be an angle γ between the specific point P and a point 920 on a wall surface orthogonal to the reference point on the basis of the reference point P900.

In FIG. 9, the reference point P900 may be a location of a user who takes an offering image with a camera. However, as described above, the reference point P900 is not limited thereto and may be a location of the camera or a predetermined specific point.

Meanwhile, the processor 630 may calculate a median value of the coordinates of the first edge 710 as a representative point 315 of the first edge 710. Further, the processor 630 may calculate an angle between the representative point 315 and the reference point as a horizontal angle. Herein, the horizontal angle corresponding to the first edge 710 may be calculated using the x-coordinate of the representative point 315 of the first edge 710/the width of the offering image*2π′.

Further, the processor 630 may calculate a vertical angle of the first edge 710 using the maximum y-coordinate of the first edge 710. Herein, the vertical angle corresponding to the first edge 710 may be calculated using “(the maximum y-coordinate of the first edge 710−the height of the camera)/the height of the image*π′.

Herein, if the offering image is an image of the inside of the offering, the edges may be uniform in length. That is, the multiple edges included in the offering image may have a uniform length and a uniform vertical angle. Therefore, the vertical angle may be calculated using the longest edge or the edge having the maximum y-coordinate among the edges.

If the edges included in the offering image are different in length, the processor 630 may calculate a vertical angle of each edge.

The processor 630 may calculate a vertical angle and a horizontal angle of each edge on the basis of the reference point, and then calculate plane coordinates of each edge using the calculated vertical and horizontal angles.

For example, the processor 630 may calculate a distance distᵢ of an edge i on the basis of Equation 1. In Equation 1, θi is a horizontal angle of the edge, hw is a height of the corresponding wall surface, and he is a height of the camera. Herein, the height of the wall surface may be received through the supplier device. Otherwise, the height of the wall surface may be previously stored corresponding to the image.

distᵢ=(hw−he)×tan(θᵢ) [Equation 1]

Then, the processor 630 may calculate plane coordinates of each edge on the basis of the reference point in a vertical direction. For example, the processor 630 may calculate the x-coordinate of the edge i using Equation 2 and calculate the y-coordinate of the edge i using Equation 3. Herein, the coordinates of each edge may be relative coordinates to the reference point.

Point_xᵢ=distᵢ×cos(θᵢ) [Equation 2]

Point_yᵢ=distᵢ×sin(θᵢ) [Equation 3]

The processor 630 may calculate plane coordinates of each edge, and then produce a floor plan using the calculated plane coordinates.

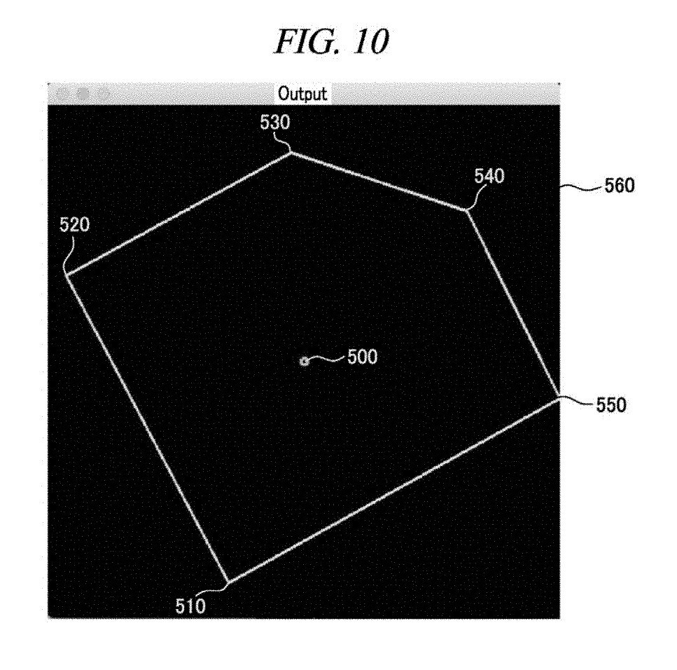

FIG. 10 is an exemplary floor plan in accordance with an exemplary embodiment of the present disclosure.

Referring to FIG. 10, the processor 630 may calculate plane coordinates 510 of the first edge 710 on the basis of information about a reference point 500 and the first edge 710 and display the plane coordinates 510 on a floor plan. Likewise, the processor 630 may calculate plane coordinates 520 of the second edge 720, plane coordinates 530 of the third edge 730, plane coordinates 540 of the fourth edge 740, and plane coordinates 550 of the fifth edge 750 on the basis of information about the reference point 500 and the respective edges and display the plane coordinates on the floor plan. Then, the processor 630 may complete the floor plan by connecting the plane coordinates of the respective edges.

The lines connecting the plane coordinates of the respective edges may be walls of the space corresponding to the offering image. That is, the wall may be a space between one edge and another edge in the image. Herein, the wall may be an actual wall or may be a virtual wall expressed only in the image.

For example, the solid line connecting the plane coordinates 510 of the first edge 710 and the plane coordinates 520 of the second edge 720 may be a first wall. The solid line connecting the plane coordinates 520 of the second edge 720 and the plane coordinates 530 of the third edge 730 may be a second wall. The solid line connecting the plane coordinates 530 of the third edge 730 and the plane coordinates 540 of the fourth edge 740 may be a third wall. The solid line connecting the plane coordinates 540 of the fourth edge 740 and the plane coordinates 550 of the fifth edge 750 may be a fourth wall. Further, the solid line connecting the plane coordinates 510 of the first edge 710 and the plane coordinates 550 of the fifth edge 750 may be a fifth wall.

Meanwhile, the processor 630 may calculate wall surface information corresponding each wall surface and extracted from the offering image on the basis of the floor surface information.

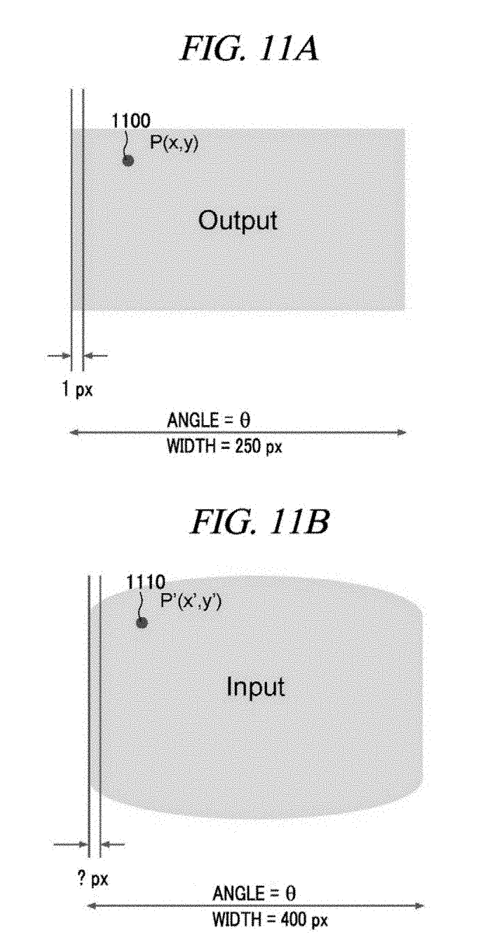

FIG. 11A and FIG. 11B provide exemplary diagrams illustrating a wall in a 3D-modeled image and a wall in a 360-degree panoramic image in accordance with an exemplary embodiment of the present disclosure. FIG. 11A is an exemplary diagram of an actual wall corresponding to the image, and FIG. 11B is an exemplary diagram of a wall in a 360-degree panoramic image.

For example, in the 360-degree panoramic image, an actually rectangular wall may be distorted in shape. The processor 630 may convert coordinates of multiple points included in the distorted 360-degree panoramic image into plane coordinates and three-dimensionally model the offering image. That is, the processor 630 may convert the 360-degree panoramic image into a 3D image on the basis of coordinates (x, y) of P 1100 corresponding to coordinates (x′, y′) of a point P′ 1110 in the 360-degree panoramic image.

Firstly, the processor 630 may calculate a shortest distance between each wall surface and the reference point. Then, the processor 630 may calculate distances between multiple points included in each wall surface and the reference point.

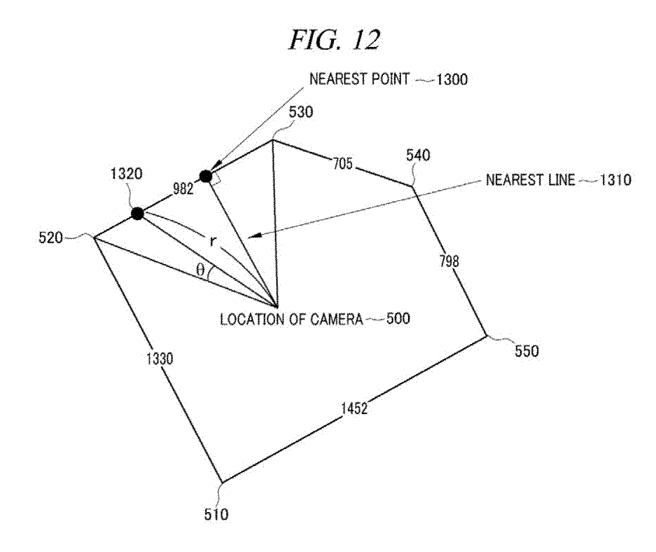

FIG. 12 is an exemplary floor plan provided to explain a 3D modeling process in accordance with an exemplary embodiment of the present disclosure.

For example, referring to FIG. 12, a nearest line 1310 having a shortest distance between the reference point 500 and a second wall surface between the second edge 720 and the third edge 730 can be calculated. Herein, the second wall surface can be calculated using the coordinates 520 of the second edge 720, the coordinates 530 of the third edge 730, and a line equation. Further, the shortest distance between the reference point 500 and the second wall surface may be calculated on the basis of information about a line passing through the reference point 500 among lines orthogonal to a straight line corresponding to the second wall surface.

Then, the processor 630 may calculate distances between multiple points on the second wall surface and the reference point 500. Herein, the multiple points divide the second wall surface by a predetermined length. For example, the predetermined length may be 1 pixel, but is not limited thereto.

Further, the processor 630 may divide the multiple points included in the second wall surface on the basis of a nearest point 1300 corresponding to the nearest line 1310. Then, the processor 630 may calculate distances between the multiple points and the reference point 500 on the basis of information about the second edge 720 or the third edge 730.

For example, the processor 630 may classify the multiple points into two groups on the basis of the nearest point 1300. The processor 630 may calculate a distance between the reference point 500 and a point included between the second edge 720 and the nearest point 1300 on the basis of the Pythagoras formula and information about the second edge 720. Further, the processor 630 may calculate a distance between the reference point 500 and a point included between the second edge 720 and the nearest point 1300 on the basis of the Pythagoras formula and information about the third edge 730.

The processor 630 may calculate distances with respect to the multiple points included in the second wall surface and then calculate distances between the reference point and multiple points included in the other wall surfaces.

Meanwhile, the processor 630 may calculate distances with respect to multiple points included in each wall surface as wall surface information and then model the offering image on a 3D image on the basis of the edge information and the wall surface information.

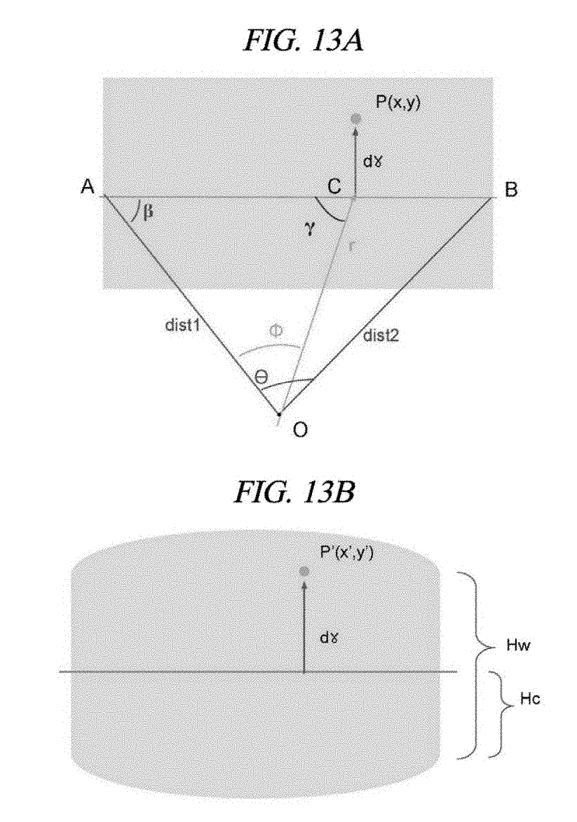

FIG. 13A and FIG. 13B provide exemplary diagrams illustrating a 3D model and a 360-degree panoramic image in accordance with an exemplary embodiment of the present disclosure. Herein, FIG. 13A is an exemplary diagram of a 3D image, and FIG. 13B is an exemplary diagram of a 360-degree panoramic image.

For example, a vertical angle between the reference point and a point P in FIG. 13A is identical to a vertical angle between the reference point and a point P′ in FIG. 13B. That is, if an angle between the point P and the reference point in the 3D image is dγ, an angle between the reference point and the point P′ in the offering image is also dγ. Herein, tan(dγ) in the 3D image may be calculated on the basis of the y-coordinate y of the point P and a distance r between the reference point and a point corresponding to the x-coordinate. Further, tan(dγ) in the offering image may be calculated on the basis of the y-coordinate y′ of the point P′ and a distance between the camera and x′.

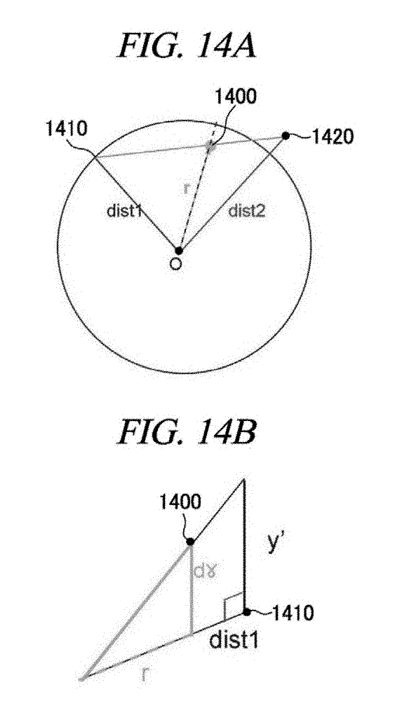

FIG. 14A and FIG. 14B provides exemplary diagrams provided to explain a 3D modeling process about an offering image in accordance with an exemplary embodiment of the present disclosure. Herein, FIG. 14A is an exemplary diagram in which relative locations of a point P 1400 and edges 1410 and 1420 are projected onto a circle. Further, FIG. 14B is an exemplary diagram showing a relative distance between the point P 1400 and a specific edge 1410 in the panoramic image.

Referring to FIG. 14A, when a circle having the radius equal to a length of one edge is drawn, the x-coordinate of the point P is present within the circle. That is, referring to FIG. 14B, the point P may be expressed higher in the offering image than it is in reality. Therefore, the y-coordinate y′ of the point P′ may be calculated on the basis of the distance distᵢ of the edge, the distance r between the camera and x′, and the angle dγ between the reference point and the point P′. For example, the coordinates of the point P′ in the offering image may be calculated as shown in Equation 4.

y′=distᵢ/r×dγ [Equation 4]

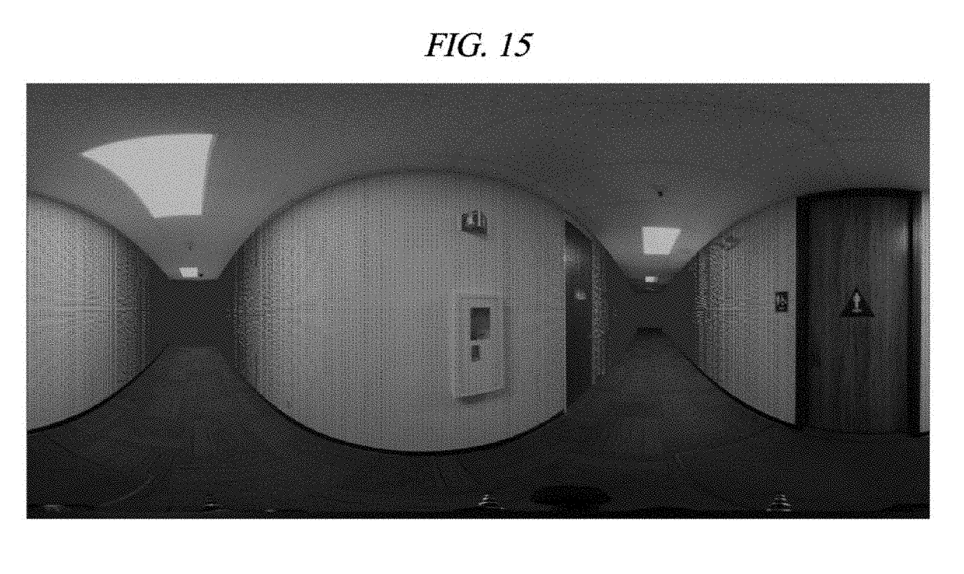

FIG. 15 is an exemplary view of a 360-degree panoramic image in which transformed coordinates are mapped in accordance with an exemplary embodiment of the present disclosure.

The processor 630 may map multiple coordinates included in an offering image to correspond to a 3D image. Then, the processor 630 may create a 3D model by modeling the 3D image as shown in FIG. 8 on the basis of edge information and transformed coordinates.

Meanwhile, the offering image may include 360-degree panoramic image data of multiple areas. Therefore, the processor 630 may create one or more 3D models to correspond to multiple 360-degree panoramic image data included in the offering image. Herein, as described above, the 360-degree image may include image data about views from all directions from a location of a camera taking panoramic image data.

The processor 630 may store one or more 3D models created using the communication module 210 in the database or may transfer the 3D models to the supplier device 300.

Further, the processor 630 may transfer image data about one direction among image data about multiple directions included in the 3D models to the supplier device 300 or the consumer device 100 depending on a setup of the supplier device 300 or consumer device 100 which receives the 3D models.

For example, the processor 630 may provide image data about a view from another direction in response to an input to change the direction by the consumer device 100. Herein, the input by the consumer device 100 may be any one of a touch input, a mouse input, and an input of movement of the consumer device 100.

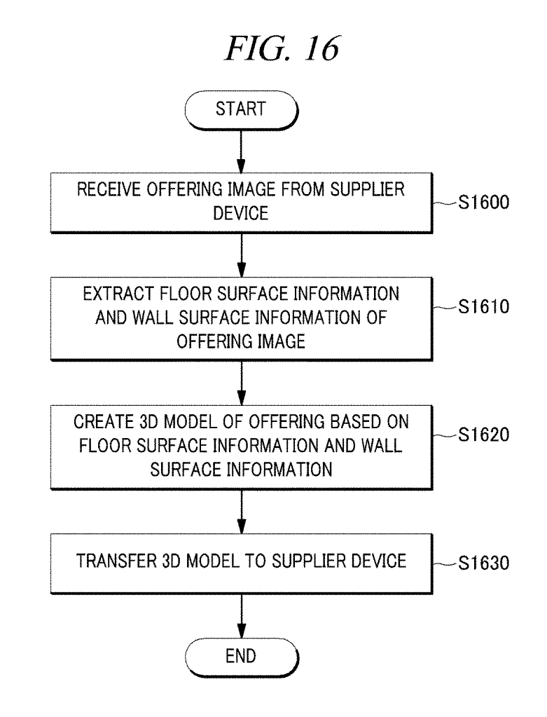

Hereinafter, referring to FIG. 16, a 3D modeling method of the 3D modeling image providing server 200 about an image in accordance with an exemplary embodiment of the present disclosure will be described.

FIG. 16 is a flowchart a 3D modeling method of the 3D modeling image providing server 200 about an offering image in accordance with an exemplary embodiment of the present disclosure.

The 3D modeling image providing server 200 receives an offering image from the supplier device 300. Then, the 3D modeling image providing server 200 may receive information about a height of a camera and information about multiple edges from the supplier device 300 (S1600). Herein, the edge is defined between a wall surface and a wall surface included in the offering image. Further, a 3D model is a stereoscopic image obtained by connecting a floor surface and a wall surface of an offering in three dimensions and mapping areas corresponding to the offering image in the respective surfaces. Furthermore, the offering image is panoramic image data obtained by combining images of the inside of the offering taken with the camera while rotating 360 degrees in place.

The 3D modeling image providing server 200 extracts floor surface information and wall surface information corresponding to the offering image on the basis of information about the height of the camera and the information about the multiple edges (S1610).

Then, the 3D modeling image providing server 200 creates a 3D model of the offering on the basis of the floor surface information and the wall surface information (S1620).

Specifically, the 3D modeling image providing server 200 may transform coordinates of the floor surface and the wall surface included in the offering image into coordinates corresponding to the 3D model. Further, the 3D modeling image providing server 200 may map the offering image into a 3D image on the basis of the coordinates corresponding to the 3D model.

Then, the 3D modeling image providing server 200 transfers the created 3D model to the supplier device (S1630).

The 3D modeling image providing server 200 and the 3D modeling method of the 3D modeling image providing server 200 in accordance with an exemplary embodiment of the present disclosure can three-dimensionally models a 360-degree panoramic image on the basis of edge information received from a supplier device. Therefore, the 3D modeling image providing server 200 and the 3D modeling method of the 3D modeling image providing server 200 enables a supplier to easily and simply provide a virtual reality-based three-dimensional image which can provide reality to a user who wants to buy or rent an offering as if the user were on the spot checking the offering.

The embodiment of the present disclosure can be embodied in a storage medium including instruction codes executable by a computer such as a program module executed by the computer. Besides, the data structure in accordance with the embodiment of the present disclosure can be stored in the storage medium executable by the computer. A computer-readable medium can be any usable medium which can be accessed by the computer and includes all volatile/non-volatile and removable/non-removable media. Further, the computer-readable medium may include all computer storage and communication media. The computer storage medium includes all volatile/non-volatile and removable/non-removable media embodied by a certain method or technology for storing information such as computer-readable instruction code, a data structure, a program module or other data. The communication medium typically includes the computer-readable instruction code, the data structure, the program module, or other data of a modulated data signal such as a carrier wave, or other transmission mechanism, and includes a certain information transmission medium.

The system and method of the present disclosure has been explained in relation to a specific embodiment, but its components or a part or all of its operations can be embodied by using a computer system having general-purpose hardware architecture.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A method for producing a virtual reality image about an object performed by a server, the method comprising:
(a) receiving, from a supplier device, a panoramic image obtained by synthesizing images taken with a camera in multiple directions from a specific reference point in a space related to the object;
(b) recognizing a feature, with which a height from a floor to a ceiling and a wall surface structure within the space of the object are obtained, from the panoramic image;
(c) creating a 3D model about the object on the basis of the feature and the panoramic image in response to an input by the supplier device; and
(d) providing a virtual reality image to a consumer device on the basis of the 3D model in response to an input to look up the object by the consumer device,
wherein the virtual reality image is a 360-degree image of the object which is provided to the consumer device as being implemented to enable each area of the 3D model to be looked up,
the 360-degree image includes image data about views from multiple directions from a location of the camera taking the images, and
the consumer device is provided with image data about a view from one direction and also provided with image data about a view from another direction in response to an input by the consumer device, and, thus, an image about the space of the object is provided to the consumer device.

2. The method for producing a virtual reality image about the inside of an object of claim 1,
wherein areas of the 3D model are respectively matched with images in the panoramic image divided by the feature,
the specific reference point where the panoramic image is taken is matched with a specific location in the 3D model, and
the virtual reality image is a 360-degree image of the object which is provided to the consumer device as being implemented to enable each area of the 3D model to be looked up, on the basis of the specific reference point.

3. The method for producing a virtual reality image about the inside of an object of claim 1,
wherein the feature is based on locations and lengths of wall edges located in the space of the object and displayed in the panoramic image.

4. The method for producing a virtual reality image about the inside of an object of claim 3,
wherein (b) the recognizing of a feature includes:
recognizing line segments displayed in the panoramic image as wall edges in response to an input by the supplier device.

5. The method for producing a virtual reality image about the inside of an object of claim 4,
wherein (c) the creating of a 3D model includes:
detecting a floor shape of the space of the object on the basis of locations of the wall edges; and
detecting a height from the floor to the ceiling in the space of the object on the basis of lengths of the wall edges.

6. The method for producing a virtual reality image about the inside of an object of claim 1, further comprising:
after (c) the creating of a 3D model, (e) editing at least one of a location, a size, a direction, and a shape of the 3D model in response to an input by the supplier device.

7. The method for producing a virtual reality image about the inside of an object of claim 6,
wherein (e) the editing of at least one of a location, a size, a direction, and a shape includes:
providing a structural plan view of the 3D model to the supplier device; and
receiving a result of editing about the location or direction of the 3D model in the structural plan view from the supplier device, and
the structural plan view includes a floor shape of the space of the object, the specific reference point, an orientation at a start time of taking the panoramic image with the camera, an image range on the basis of the specific reference point in which the 3D model is provided on a screen of the consumer device, and image data corresponding to an image range currently provided to the consumer device.

8. The method for producing a virtual reality image about the inside of an object of claim 6,
wherein (e) the editing of at least one of a location, a size, a direction, and a shape includes:
receiving an input to specify a certain area of the 3D model as a polygonal shape from the supplier device;
deleting image data in the area corresponding to the polygonal shape; and
when multiple 3D models of the object are created and another 3D model is adjacent to the 3D model, displaying an image of the other 3D model through the deleted area.

9. The method for producing a virtual reality image about the inside of an object of claim 1, further comprising:
when the object includes multiple rooms and the whole inside space is not covered in one panoramic image,
(f) creating multiple 3D models corresponding to the object by repeatedly performing (a) through (c) to another room of the object after (c) the creating of a 3D model.

10. The method for producing a virtual reality image about the inside of an object of claim 9,
wherein (e) the editing of at least one of a location, a size, a direction, and a shape includes:
forming a link or cancelling a previously formed link between adjacent 3D models upon receipt of an input to specify between specific reference points of the multiple 3D models from the supplier device, and
the formed link and the canceled link are separated based on at least one of a type, a color, and a thickness of a line connecting between reference points of the adjacent 3D models.

11. A server for producing a virtual reality image about an object, comprising:
a memory that stores therein a program for performing a method for producing a virtual reality image about an object; and
a processor for executing the program,
wherein upon execution of the program, the processor receives, from a supplier device, a panoramic image obtained by combining images taken with a camera in multiple directions from a specific reference point in a space related to the object, recognizes a feature, with which a height from a floor to a ceiling and a wall surface structure within the space of the object are obtained, from the panoramic image, creates a 3D model about the object on the basis of the feature and the panoramic image in response to an input by the supplier device, and provides a virtual reality image to a consumer device on the basis of the 3D model in response to an input to look up the object by the consumer device,
the virtual reality image is a 360-degree image of the object which is provided to the consumer device as being implemented to enable each area of the 3D model to be looked up,
the 360-degree image includes image data about views from multiple directions from a location of the camera taking the images, and
the consumer device is provided with image data about a view from one direction and also provided with image data about a view from another direction in response to an input by the consumer device, and, thus, an image about the space of the object is provided to the consumer device.

12. A server for producing a virtual reality image about an object, comprising:
a communication module that performs data communication with a supplier device;
a memory that stores therein a program for performing a method for producing a virtual reality image about an object; and
a processor for executing the program,
wherein upon execution of the program, the processor receives, from the supplier device, an object image which is a panoramic image obtained by synthesizing images taken with a camera in multiple directions from a specific reference point in a space of the object, extracts floor surface information and wall surface information corresponding to the panoramic image on the basis of camera information of the panoramic image and information about at least one edge, creates a 3D model of the object from the panoramic image on the basis of the floor surface information and the wall surface information, provides the 3D model to the supplier model, and provides a virtual reality image to a consumer device on the basis of the 3D model in response to an input to look up the object by the consumer device,
the edge is defined between a wall surface and a wall surface included in the panoramic image, and
the 3D model is a 3D image generated by mapping images corresponding to surfaces in the panoramic image into a stereoscopic structure about the object.

13. The server for providing a 3D modeling image of claim 12,
wherein the processor receives, from the supplier device, information about a height of the camera corresponding to the panoramic image and information about the multiple edges.

14. The server for providing a 3D modeling image of claim 13,
wherein the processor transforms coordinates of a floor surface and a wall surface included in the panoramic image on the basis of the floor surface information and the wall surface information into coordinates corresponding to the 3D model, and maps the panoramic image into the 3D model on the basis of the coordinates corresponding to the 3D model.

15. The server for providing a 3D modeling image of claim 14,
wherein the floor surface information includes a horizontal angle, a vertical angle, and plane coordinates of each of the multiple edges, and
the processor calculates a horizontal angle and a vertical angle between each of the edges and the camera on the basis of information of the multiple edges, and calculates plane coordinates corresponding to each of the edges on the basis of the horizontal angle and the vertical angle of each of the edges.

16. The server for providing a 3D modeling image of claim 14,
wherein the wall surface information includes distances between the camera and multiple wall points defined on a plan position where a wall connecting any two of the multiple edges is placed.

17. The server for providing a 3D modeling image of claim 17,
wherein the processor calculates distances between the camera and multiple wall points included in a first wall on the basis of information about a first edge and a second edge included in the multiple edges, extracts the calculated distances corresponding to the multiple wall points as information about the first wall,
the first wall corresponds to a space between the first edge and the second edge, and
the multiple wall points divide the first wall by a predetermined length.

18. The server for providing a 3D modeling image of claim 17,
wherein the processor transforms coordinates of a point on the first wall in the panoramic image into coordinates corresponding to the 3D model on the basis of a distance between the camera and any one of the first edge and the second edge and the distances between the camera and the multiple wall points.

19. The server for providing a 3D modeling image of claim 12,
wherein the processor provides a user interface to the supplier device, and extracts the edge information,
the user interface is configured to display a panoramic image on the supplier device, and
the edge information is extracted from the panoramic image by the processor, or is extracted by receiving an input signal input to the panorama image by the supplier device through the user interface.

20. The server for providing a 3D modeling image of claim 12,
wherein the panoramic image includes multiple panoramic image data corresponding to multiple areas, and
the processor creates multiple 3D models respectively corresponding to the multiple panoramic image data.
